(19) United States
(12) Patent Application Publication
(10) Pub. No.: US 2023/0344804 A1
(43) Pub. Date: Oct. 26, 2023

(54) METHODS AND APPARATUS TO INCREASE PRIVACY FOR FOLLOW-ME SERVICES

(71) Applicant: Intel Corporation, Santa Clara, CA (US)

(72) Inventors: Akhilesh Thyagaturu, Tempe, AZ (US); Vijay Sarathi Kesavan, Portland, OR (US); Mats Agerstam, Portland, OR (US)

(21) Appl. No.: 18/343,671

(22) Filed: Jun. 28, 2023

(51) Int. Cl. H04L 9/40

(52) U.S. Cl. CPC H04L 63/0421; H04L 63/0428

(57) ABSTRACT

Methods, apparatus, systems, and articles of manufacture to migrate cloud-based workloads are disclosed. An example instructions cause programmable circuitry to at least cause transmission of anonymized information corresponding to a user device to a network device; and cause migration of a virtual execution environment from a first compute device to a second compute device based on a response from the network device, the virtual execution environment to execute at least a portion of a workload for an end user device.

### BACKGROUND

In recent years, edge compute nodes have been implemented to execute tasks to provide services for end user devices. For example, when a user utilizes a service provided by a service provider (also referred to as a third-party service provider), instead of the edge compute node(s) execute the task(s) and provide the outputs to the end user device. In this manner, the resources of the end user device are conserved. If an end user device is a mobile device (e.g., a smart phone, a tablet, a laptop, etc.), the end user device can move away from the edge compute node that is currently executing the tasks for the end user device. As the end user device moves farther from the edge compute node, the performance, quality, experience, of the user of the service decreases (e.g., latency increases, throughput decreases, etc.).

### BRIEF DESCRIPTION OF THE DRAWINGS

FIG. 1 illustrates an overview of an edge cloud configuration for edge computing.

FIG. 2 illustrates operational layers among endpoints, an edge cloud, and cloud computing environments.

FIG. 3 is a block diagram of an example environment for networking and services in an edge computing system.

FIG. 4 illustrates deployment of a virtual edge configuration in an edge computing system operated among multiple edge nodes and multiple tenants.

FIG. 5 illustrates various compute arrangements deploying virtual execution environments in an edge computing system.

FIG. 6 illustrates an example compute and communication use case involving mobile access to applications in an example edge computing system.

FIG. 7 is a block diagram of an example system described in conjunction with example teachings disclosed herein to increase privacy for follow-me services.

FIG. 8 is a block diagram of an example implementation of the processor circuitry of FIG. 7.

FIG. 9 is a block diagram of an example implementation of the radio access network intelligent controller circuitry of FIG. 7.

FIG. 10 is a flowchart representative of example machine readable instructions and/or operations that may be executed, instantiated, and/or performed by programmable circuitry to implement the example processor circuitry of FIG. 8 and/or the example radio access network intelligent controller of FIG. 9.

FIG. 11 is a block diagram of an example processor platform including programmable circuitry structured to execute, instantiate, and/or perform the computer readable instructions and/or perform the example operations of FIG. 10 to implement the example radio access network intelligent controller of FIG. 9.

FIG. 12A is a block diagram of an example implementation of an example compute node that may be deployed in one of the edge computing systems illustrated in FIGS. 1 and/or 7.

FIG. 12B is a block diagram of an example processor platform including programmable circuitry structured to execute, instantiate, and/or perform the computer readable instructions and/or perform the example operations of FIG. 10 to implement the example processor circuitry of FIG. 8.

FIG. 13 is a block diagram of an example implementation of the programmable circuitry of FIGS. 8 and/or 9.

FIG. 14 is a block diagram of another example implementation of the programmable circuitry of FIGS. 8 and/or 9.

FIG. 15 is a block diagram of an example software/firmware/instructions distribution platform (e.g., one or more servers) to distribute software, instructions, and/or firmware (e.g., corresponding to the example machine readable instructions of FIG. 10 to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. In general, the same reference numbers will be used throughout the drawing(s) and accompanying written description to refer to the same or like parts. The figures are not necessarily to scale.

### DETAILED DESCRIPTION

Descriptors “first,” “second,” “third,” etc. are used herein when identifying multiple elements or components which may be referred to separately. Unless otherwise specified or understood based on their context of use, such descriptors are not intended to impute any meaning of priority or ordering in time but merely as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

Workloads (e.g., application programming running on a computing device) continue to move off personal computers (PCs) and mobile devices to the cloud where they are executed as part of a service package. For example, Word Processing and Spreadsheets by companies like MICROSOFT™ (‘teams’) and GOOGLE™ (‘docs’) have been pushed from PCs to the cloud. In such examples, an end user device may utilize an application maintained by a service provider. The application running on the end user device can communicate with a corresponding producer application in the cloud and/or the edge that executes portion(s) of the workload instead of executing the workload at the end user device. In such examples, the edge and/or cloud computing devices install a virtual execution environment (e.g., one or more containers, virtual machines, applications, software, etc.) to be able to execute the workload and transmit results to the end user device to provide a service to the end user.

Although cloud and edge devices typically remain stationary, end user devices can also travel from one location to another location. For example, an end user device may be carried by a user or a device (e.g., a drone, a car, etc.) from one location to another. Although the service provider may select an edge and/or cloud device that is located near the end user device when a service is first initiated, as the end user device moves, the edge and/or cloud device may no longer be close to the end user device. As the distance between the end user device and the edge device increases, the overall performance and/or the user device experience decreases. For example, the further the end user device is from the edge device, the lower the throughput, higher the delay, higher the number of dropped packets, etc. Accordingly, protocols may be in place to migrate the functionality that executes the tasks from the first edge device to the second edge device closer to the end user device to increase performance. Such protocols may be referred to as follow-me services. In examples disclosed herein to increase performance and/or user device experience, a virtual execution environment capable of executing the workload can migrate from the edge device to a different edge device that is located closer to the end user device.

In order to determine which edge device(s) are near the end user device to migrate a service to increase performance, the cloud/edge service provider attempts to track the location of the user. In some examples, the cloud/edge service provider can ask permission to track the position of the user. If the user accepts the request, the cloud/edge service provider gathers location information from the access networks (e.g., base stations, cellular networks, private network, access points, etc.) to migrate a virtual execution environment from one edge device to another edge device closer to the end user device. However, some users may not want to have a service provider know and/or track the location of the user. For example, some users may want to preserve privacy from third party service providers. Additionally, some users may fear data leaks and/or security loop holes at the third party cloud/edge service provider may compromise user location to an attacker.

Examples disclosed herein preserve privacy of user and/or location information associated with an end user device while still facilitating migration of third-party services within a cloud and/or edge network. Examples disclosed herein enables a protocol at an access device (e.g., a base station, a cellular base station, an access point, etc.) of an access network to provide encrypted user and/or location information corresponding to an end user device to the third party service provider along with a computation key using oblivious encryption. Oblivious encryption enables a device to obtain and process decrypted data with the computational key without decrypting and/or otherwise determining the decrypted information. In this manner, the third party service provider can process the encrypted location and/or user information using the computation key to determine a set of candidate edge and/or cloud compute devices that are near the end device without decrypting, and/or otherwise being able to determine, the encrypted location and/or user information. Accordingly, the third-party edge device can provide the edge and/or cloud compute devices as candidates for service migration without being able to identify the actual location and/or identity of the end user of the end user device. The third party service provider provides the candidate edge and/or cloud compute nodes to the access device and the access device decrypted the encrypted response and selects one of the candidates to migrate a service to. The access device transmits migration instructions to the edge and/or compute nodes and/or an orchestrator of the edge and/or compute nodes to facilitate the migration of the service from the prior edge and/or compute node to the selected edge and/or compute node. Thus, service is migrated to improve service execution performance without compromising (e.g., while preserving) the privacy of the end user. Examples disclosed herein may be used in a zero trust environment or a low trust environment.

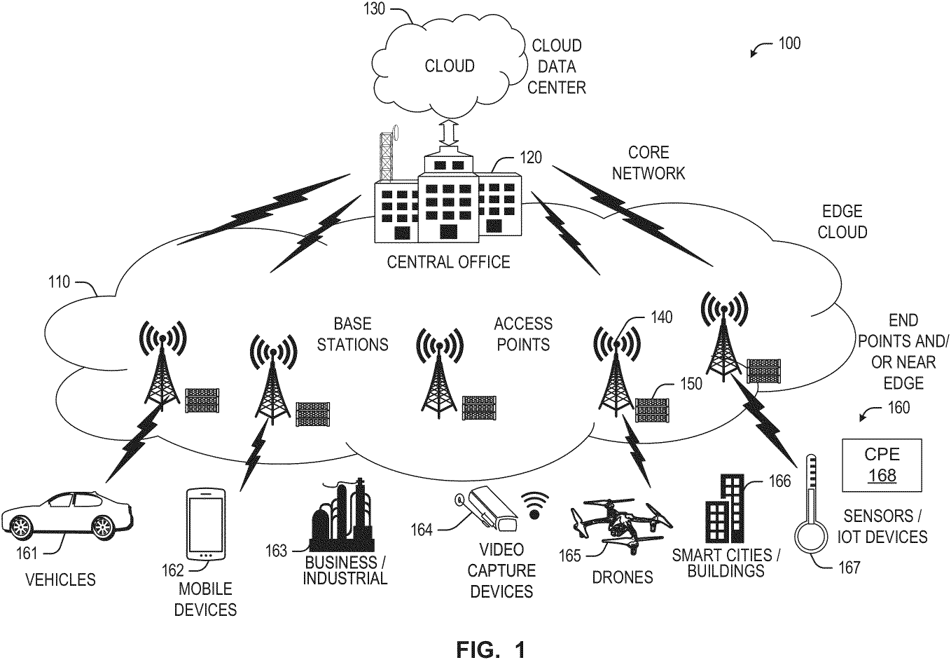

FIG. 1 is a block diagram 100 showing an overview of a configuration for edge computing, which includes a layer of processing referred to in many of the following examples as an “edge cloud.” As shown, the edge cloud 110 is co-located at an edge location, such as an access point, base station, or access device 140, a local processing hub 150, or a central office 120, and thus may include multiple entities, devices, and equipment instances. The edge cloud 110 is located much closer to the endpoint (consumer and producer) data sources and/or end points 160 (e.g., autonomous vehicles 161, user equipment 162, business and industrial equipment 163, video capture devices 164, drones 165, smart cities and building devices 166, sensors and IoT devices 167, Consumer/Customer Presence Equipment 168, etc.) than the cloud data center 130. The Consumer/Customer Presence Equipment 168 may include a gateway or home edge device. In some examples, the mobile device 162, the vehicle 161, the IoT devices 167, a home computing device, etc. may connect with the CPE 168. Compute, memory, and storage resources which are offered at the edges in the edge cloud 110 are critical to providing ultra-low latency response times for services and functions used by the endpoint data sources 160 as well as reduce network backhaul traffic from the edge cloud 110 toward cloud data center 130 thus improving energy consumption and overall network usages among other benefits. In some examples, the end points 160 may be included in the edge cloud 110 as part of a near edge of the edge cloud 110.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the amount of resources needed for network services, through the distribution of more resources which are located closer both geographically and in network access time. In this manner, edge computing attempts to bring the compute resources to the workload data where appropriate, or bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “device edge,” “near edge”, “close edge”, “local edge”, “middle edge”, “user device edge,” or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

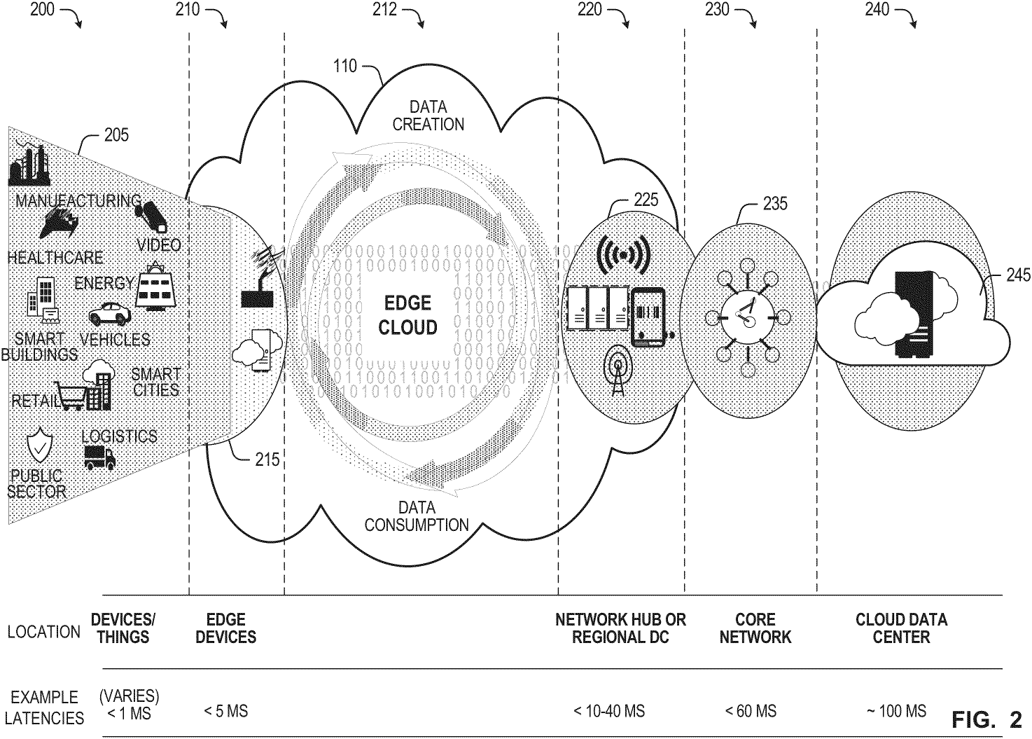

FIG. 2 illustrates operational layers among endpoints, an edge cloud, and cloud computing environments. Specifically, FIG. 2 depicts examples of computational use cases 205, utilizing the edge cloud 110 among multiple illustrative layers of network computing. The layers begin at an endpoint (devices and things) layer 200, which accesses the edge cloud 110 to conduct data creation, analysis, and data consumption activities. The edge cloud 110 may span multiple network layers, such as an edge devices layer 210 having gateways, on-premise servers, or network equipment (nodes 215) located in physically proximate edge systems; a network access layer 220, encompassing base stations, radio processing units, network hubs, regional data centers (DC), or local network equipment (equipment 225); and any equipment, devices, or nodes located therebetween (in layer 212, not illustrated in detail). The network communications within the edge cloud 110 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 200, under 5 ms at the edge devices layer 210, to even between 10 to 40 ms when communicating with nodes at the network access layer 220. Beyond the edge cloud 110 are core network 230 and cloud data center 240 layers, each with increasing latency (e.g., between 50-60 ms at the core network layer 230, to 100 or more ms at the cloud data center layer). As a result, operations at a core network data center 235 or a cloud data center 245, with latencies of at least 50 to 100 ms or more, will not be able to accomplish many time-critical functions of the use cases 205. Each of these latency values are provided for purposes of illustration and contrast; it will be understood that the use of other access network mediums and technologies may further reduce the latencies. In some examples, respective portions of the network may be categorized as “device edge”, “close edge”, “local edge”, “near edge”, “middle edge”, or “far edge” layers, relative to a network source and destination. For instance, from the perspective of the core network data center 235 or a cloud data center 245, a central office or content data network may be considered as being located within a “near edge” layer (“near” to the cloud, having high latency values when communicating with the devices and endpoints of the use cases 205), whereas an access point, base station, on-premise server, or network gateway may be considered as located within a “far edge” layer (“far” from the cloud, having low latency values when communicating with the devices and endpoints of the use cases 205). It will be understood that other categorizations of a particular network layer as constituting a “close”, “local”, “near”, “middle”, or “far” edge may be based on latency, distance, number of network hops, or other measurable characteristics, as measured from a source in any of the network layers 200-240.

The various use cases 205 may access resources under usage pressure from incoming streams, due to multiple services utilizing the edge cloud. To achieve results with low latency, the services executed within the edge cloud 110 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to SLA, the system as a whole (components in the transaction) may provide the ability to (1) understand the impact of the SLA violation, and (2) augment other components in the system to resume overall transaction SLA, and (3) implement steps to remediate.

Thus, with these variations and service features in mind, edge computing within the edge cloud 110 may provide the ability to serve and respond to multiple applications of the use cases 205 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), standard processes, etc.), which cannot leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required because edge locations may be unmanned and may even need permissioned access (e.g., when housed in a third-party location). Such issues are magnified in the edge cloud 110 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 110 (network layers 200-240), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 110.

As such, the edge cloud 110 is formed from network components and functional features operated by and within edge gateway nodes, edge aggregation nodes, or other edge compute nodes among network layers 210-230. The edge cloud 110 thus may be embodied as any type of network that provides edge computing and/or storage resources which are proximately located to radio access network (RAN) capable endpoint devices (e.g., mobile computing devices, IoT devices, smart devices, etc.), which are discussed herein. Additionally or alternatively, the edge cloud 110 may be a home network that is connected to the edge and/or could via a FIOS link or a cable network. In other words, the edge cloud 110 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 4G/5G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

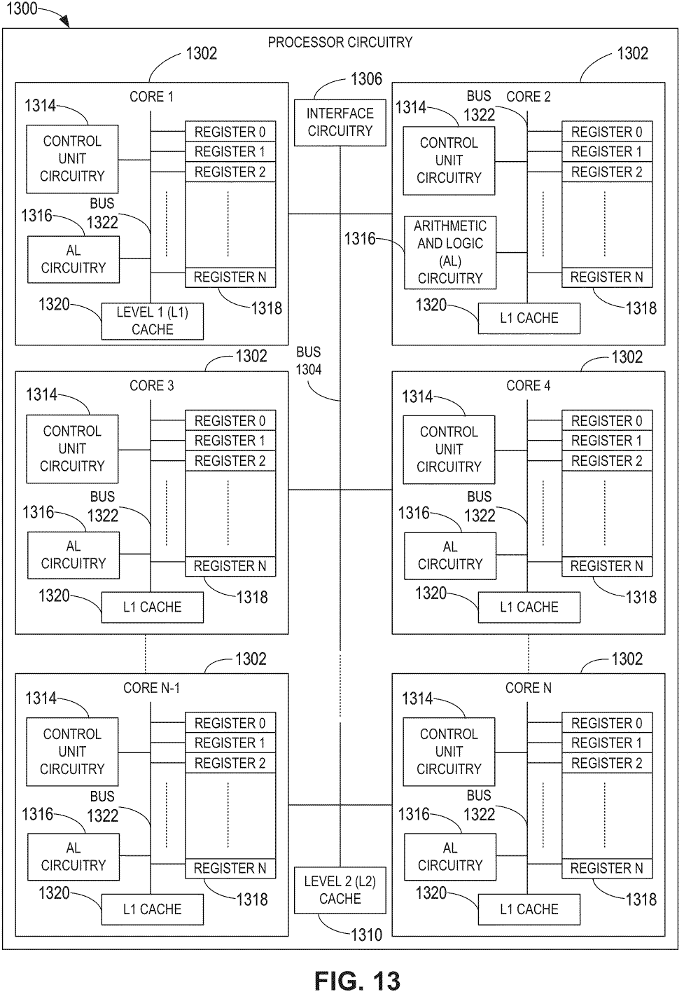

The network components of the edge cloud 110 may be servers, multi-tenant servers, appliance computing devices, set up, home gateway, client work station, client mobile personal computer (PC), smart phone, and/or any other type of computing devices. For example, the edge cloud 110 may be an appliance computing device that is a self-contained processing system including a housing, case, or shell. In some cases, edge devices are devices presented in the network for a specific purpose (e.g., a traffic light), but that have processing or other capacities that may be harnessed for other purposes. Such edge devices may be independent from other networked devices and provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. 13B. The edge cloud 110 may also include one or more servers and/or one or more multi-tenant servers. Such a server may implement a virtual computing environment such as a hypervisor for deploying virtual machines, an operating system that implements virtual execution environments, etc. Such virtual computing environments provide an execution environment in which one or more applications may execute while being isolated from one or more other applications.

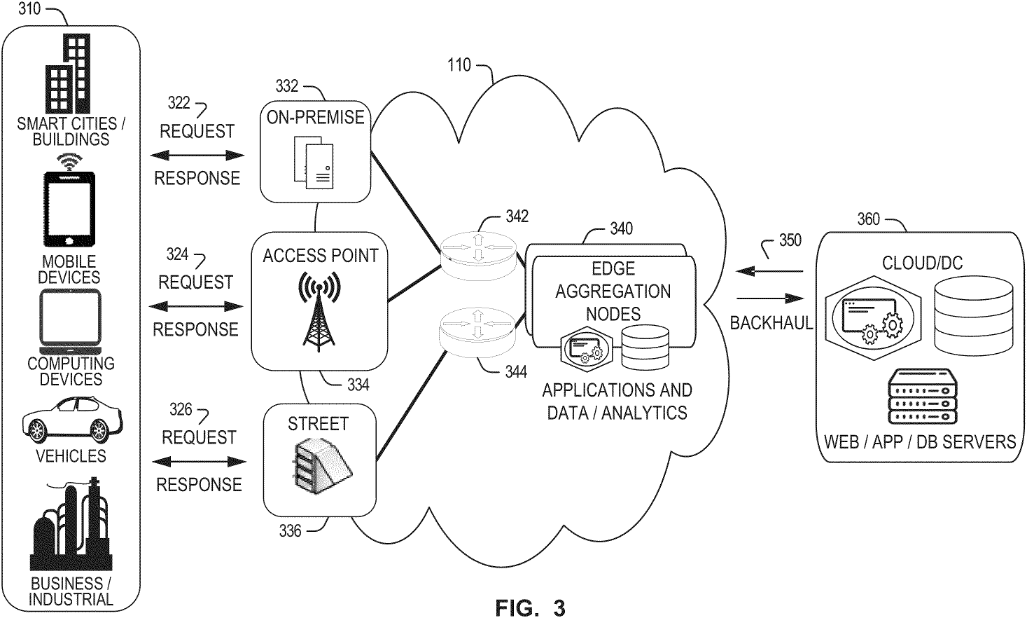

FIG. 3 illustrates a block diagram of an example environment 300 in which various client endpoints 310 (in the form of mobile devices, computers, autonomous vehicles, business computing equipment, industrial processing equipment) exchange requests and responses with the example edge cloud 110. For instance, client endpoints 310 may obtain network access via a wired broadband network, by exchanging requests and responses 322 through an on-premise network system 332. Some client endpoints 310, such as mobile computing devices, may obtain network access via a wireless broadband network, by exchanging requests and responses 324 through an access point (e.g., cellular network tower) 334. Some client endpoints 310, such as autonomous vehicles may obtain network access for requests and responses 326 via a wireless vehicular network through a street-located network system 336. However, regardless of the type of network access, the TSP may deploy aggregation points 342, 344 within the edge cloud 110 to aggregate traffic and requests. Thus, within the edge cloud 110, the TSP may deploy various compute and storage resources, such as at edge aggregation nodes 340, to provide requested content. The edge aggregation nodes 340 and other systems of the edge cloud 110 are connected to a cloud or data center 360, which uses a backhaul network 350 to fulfill higher-latency requests from a cloud/data center for websites, applications, database servers, etc. Additional or consolidated instances of the edge aggregation nodes 340 and the aggregation points 342, 344, including those deployed on a single server framework, may also be present within the edge cloud 110 or other areas of the TSP infrastructure.

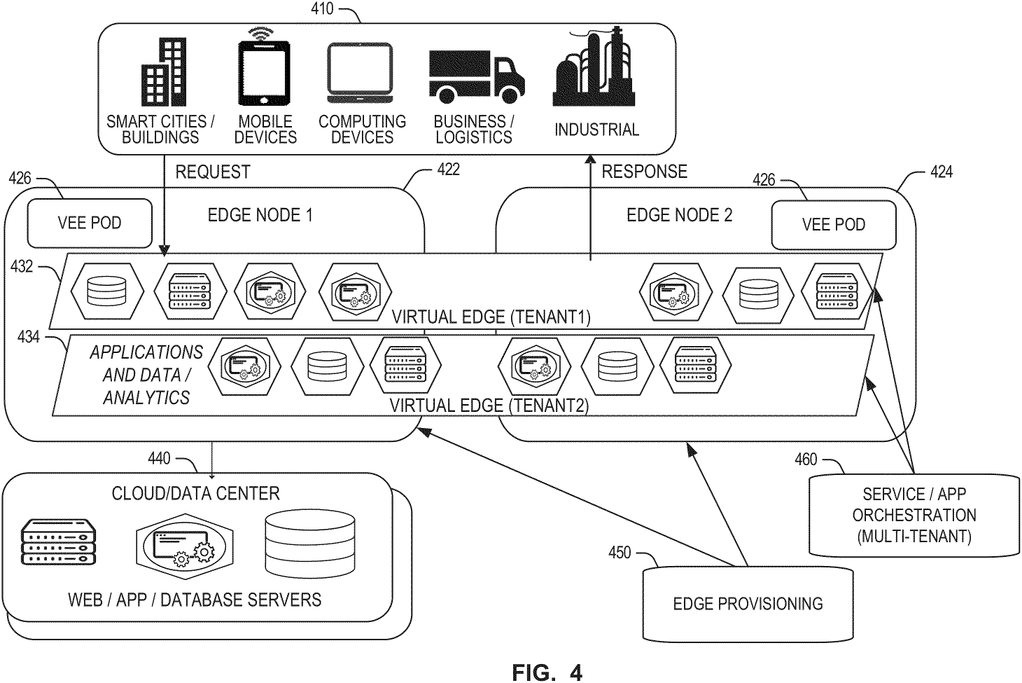

FIG. 4 illustrates deployment and orchestration for virtual edge configurations across an edge computing system operated among multiple edge nodes and multiple tenants. Specifically, FIG. 4 depicts coordination of a first edge node 422 and a second edge node 424 in an edge computing system 400, to fulfill requests and responses for various client endpoints 410 (e.g., smart cities / building systems, mobile devices, computing devices, business/logistics systems, industrial systems, etc.), which access various virtual edge instances. Here, the virtual edge instances 432, 434 provide edge compute capabilities and processing in an edge cloud, with access to a cloud/data center 440 for higher-latency requests for websites, applications, database servers, etc. However, the edge cloud enables coordination of processing among multiple edge nodes for multiple tenants or entities.

In the example of FIG. 4, these virtual edge instances include: a first virtual edge 432, offered to a first tenant (Tenant 1), which offers a first combination of edge storage, computing, and services; and a second virtual edge 434, offering a second combination of edge storage, computing, and services. The virtual edge instances 432, 434 are distributed among the edge nodes 422, 424, and may include scenarios in which a request and response are fulfilled from the same or different edge nodes. The configuration of the edge nodes 422, 424 to operate in a distributed yet coordinated fashion occurs based on edge provisioning functions 450. The functionality of the edge nodes 422, 424 to provide coordinated operation for applications and services, among multiple tenants, occurs based on orchestration functions 460.

It should be understood that some of the devices 410 are multi-tenant devices where Tenant 1 may function within a tenant1 ‘slice’ while a Tenant 2 may function within a tenant2 ‘slice’ (and, in further examples, additional or sub-tenants may exist; and each tenant may even be specifically entitled and transactionally tied to a specific set of features all the way day to specific hardware features). A trusted multi-tenant device may further contain a tenant-specific cryptographic key such that the combination of key and slice may be considered a “root of trust” (RoT) or tenant specific RoT. A RoT may further be computed dynamically composed using a DICE (Device Identity Composition Engine) architecture such that a single DICE hardware building block may be used to construct layered trusted computing base contexts for layering of device capabilities (such as a Field Programmable Gate Array (FPGA)). The RoT may further be used for a trusted computing context to enable a “fan-out” that is useful for supporting multi-tenancy. Within a multi-tenant environment, the respective edge nodes 422, 424 may operate as security feature enforcement points for local resources allocated to multiple tenants per node. Additionally, tenant runtime and application execution (e.g., in instances 432, 434) may serve as an enforcement point for a security feature that creates a virtual edge abstraction of resources spanning potentially multiple physical hosting platforms. Finally, the orchestration functions 460 at an orchestration entity may operate as a security feature enforcement point for marshalling resources along tenant boundaries.

Edge computing nodes may partition resources (memory, central processing unit (CPU), graphics processing unit (GPU), interrupt controller, input/output (I/O) controller, memory controller, bus controller, etc.) where respective partitionings may contain a RoT capability and where fan-out and layering according to a DICE model may further be applied to Edge Nodes. Cloud computing nodes consisting of virtual execution environments, FaaS engines, Servlets, servers, or other computation abstraction may be partitioned according to a DICE layering and fan-out structure to support a RoT context for each. Accordingly, the respective devices 410, 422, and 440 spanning RoTs may coordinate the establishment of a distributed trusted computing base (DTCB) such that a tenant-specific virtual trusted secure channel linking all elements end to end can be established.

Further, it will be understood that a virtual execution environment (e.g., a container, a virtual machine, etc.) may have data or workload specific keys protecting its content from a previous edge node. As part of migration of a virtual execution environment, a pod controller at a source edge node may obtain a migration key from a target edge node pod controller where the migration key is used to wrap the virtual execution environment-specific keys. When the virtual execution environment/pod is migrated to the target edge node, the unwrapping key is exposed to the pod controller that then decrypts the wrapped keys. The keys may now be used to perform operations on virtual execution environment specific data. The migration functions may be gated by properly attested edge nodes and pod managers (as described above).

In further examples, an edge computing system is extended to provide for orchestration of multiple applications through the use of virtual execution environments (deployable execution environment that provides code and needed dependencies to execute instructions (e.g., a program)) in a multi-owner, multi-tenant environment. A multi-tenant orchestrator may be used to perform key management, trust anchor management, and other security functions related to the provisioning and lifecycle of the trusted ‘slice’ concept in FIG. 4. For instance, an edge computing system may be configured to fulfill requests and responses for various client endpoints from multiple virtual edge instances (and, from a cloud or remote data center). The use of these virtual edge instances may support multiple tenants and multiple applications (e.g., augmented reality (AR)/virtual reality (VR), enterprise applications, content delivery, gaming, compute offload) simultaneously. Further, there may be multiple types of applications within the virtual edge instances (e.g., normal applications; latency sensitive applications; latency-critical applications; user plane applications; networking applications; etc.). The virtual edge instances may also be spanned across systems of multiple owners at different geographic locations (or, respective computing systems and resources which are co-owned or co-managed by multiple owners).

For instance, each of the edge nodes 422, 424 may implement the use of virtual execution environments, such as with the use of a virtual execution environment (VEE) “pod” 426, 428 providing a group of one or more virtual execution environments. In a setting that uses one or more virtual execution environment pods, a pod controller or orchestrator is responsible for local control and orchestration of the virtual execution environments in the pod. Various edge node resources (e.g., storage, compute, services, depicted with hexagons) provided for the respective edge slices 432, 434 are partitioned according to the needs of each virtual execution environment.

With the use of virtual execution environment pods, a pod controller oversees the partitioning and allocation of virtual execution environments and resources. The pod controller receives instructions from an orchestrator (e.g., the orchestrator 460) that instructs the controller on how best to partition physical resources and for what duration, such as by receiving key performance indicator (KPI) targets based on SLA contracts. The pod controller determines which virtual execution environment requires which resources and for how long in order to complete the workload and satisfy the SLA. The pod controller also manages virtual execution environment lifecycle operations such as: creating the virtual execution environment, provisioning it with resources and applications, coordinating intermediate results between multiple virtual execution environments working on a distributed application together, dismantling virtual execution environments when workload completes, and the like. Additionally, a pod controller may serve a security role that prevents assignment of resources until the right tenant authenticates or prevents provisioning of data or a workload to a virtual execution environment until an attestation result is satisfied.

Also, with the use of virtual execution environment pods, tenant boundaries can still exist but in the context of each pod of virtual execution environments. If each tenant specific pod has a tenant specific pod controller, there will be a shared pod controller that consolidates resource allocation requests to avoid typical resource starvation situations. Further controls may be provided to ensure attestation and trustworthiness of the pod and pod controller. For instance, the orchestrator 460 may provision an attestation verification policy to local pod controllers that perform attestation verification. If an attestation satisfies a policy for a first tenant pod controller but not a second tenant pod controller, then the second pod could be migrated to a different edge node that does satisfy it. Alternatively, the first pod may be allowed to execute and a different shared pod controller is installed and invoked prior to the second pod executing.

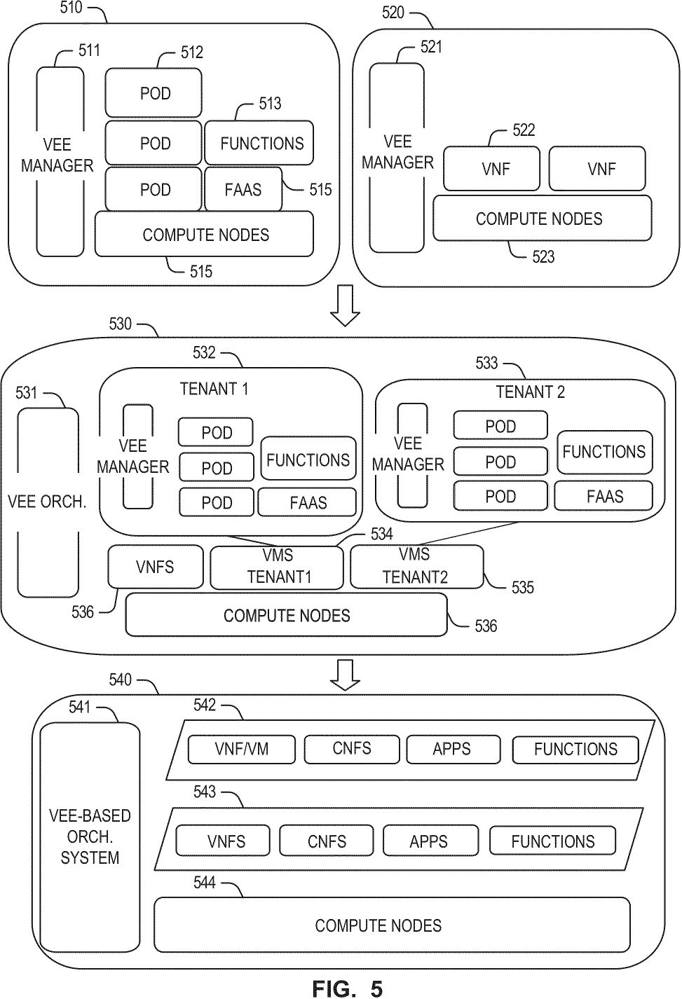

FIG. 5 illustrates additional compute arrangements deploying virtual execution environments in an edge computing system. As a simplified example, system arrangements 510, 520 depict settings in which a pod controller (e.g., virtual execution environment (VEE) managers 511, 521, and a virtual execution environment (VEE) orchestrator 531) is adapted to launch virtual execution environment pods, functions, and functions-as-a-service instances through execution via compute nodes (515 in arrangement 510), or to separately execute containerized virtualized network functions through execution via compute nodes (523 in arrangement 520). This arrangement is adapted for use of multiple tenants in an example system arrangement 530 (using compute nodes 537), where virtual execution environment pods (e.g., pods 512), functions (e.g., functions 513, VNFs 522, 536), and functions-as-a-service instances (e.g., FaaS instance 514) are launched within virtual machines (e.g., VMs 534, 535 for tenants 532, 533) specific to respective tenants (aside the execution of virtualized network functions). This arrangement is further adapted for use in system arrangement 540, which provides virtual execution environment 542, 543, or execution of the various functions, applications, and functions on compute nodes 544, as coordinated by an virtual execution environment (VEE)-based orchestration system 541.

The system arrangements of depicted in FIG. 5 provides an architecture that treats virtual execution environments (e.g., VMs and/or virtual execution environments equally in terms of application composition (and resulting applications are combinations of these three ingredients). Each ingredient may involve use of one or more accelerator (FPGA, ASIC) components as a local backend. In this manner, applications can be split across multiple edge owners, coordinated by an orchestrator.

In the context of FIG. 5, the pod controller/virtual execution environment manager, virtual execution environment orchestrator, and individual nodes may provide a security enforcement point. However, tenant isolation may be orchestrated where the resources allocated to a tenant are distinct from resources allocated to a second tenant, but edge owners cooperate to ensure resource allocations are not shared across tenant boundaries. Or, resource allocations could be isolated across tenant boundaries, as tenants could allow “use” via a subscription or transaction/contract basis. In these contexts, virtualization, virtual execution environmentalization, enclaves, and hardware partitioning schemes may be used by edge owners to enforce tenancy. Other isolation environments may include: bare metal (dedicated) equipment, virtual machines, virtual execution environments, virtual machines on virtual execution environments, or combinations thereof.

In further examples, aspects of software-defined or controlled silicon hardware, and other configurable hardware, may integrate with the applications, functions, and services an edge computing system. Software defined silicon may be used to ensure the ability for some resource or hardware ingredient to fulfill a contract or service level agreement, based on the ingredient’s ability to remediate a portion of itself or the workload (e.g., by an upgrade, reconfiguration, or provision of new features within the hardware configuration itself).

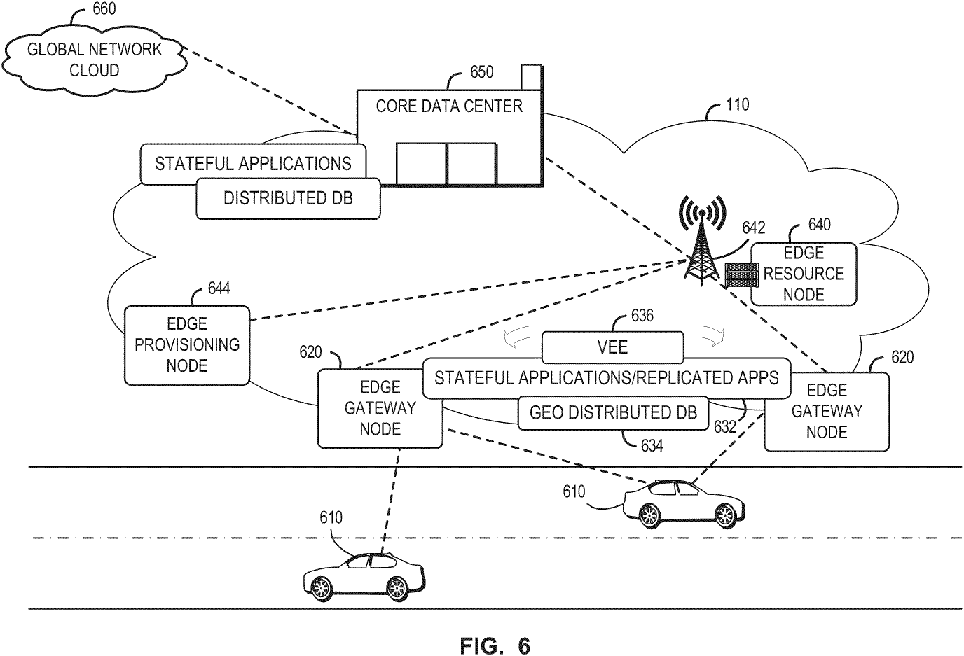

It should be appreciated that the edge computing systems and arrangements discussed herein may be applicable in various solutions, services, and/or use cases involving mobility. As an example, FIG. 6 shows an example simplified vehicle compute and communication use case involving mobile access to applications in an example edge computing system 600 that implements an edge cloud such as the edge cloud 110 of FIG. 1. In this use case, respective client compute nodes 610 may be embodied as in-vehicle compute systems (e.g., in-vehicle navigation and/or infotainment systems) located in corresponding vehicles which communicate with example edge gateway nodes 620 during traversal of a roadway. For instance, the edge gateway nodes 620 may be located in a roadside cabinet or other enclosure built-into a structure having other, separate, mechanical utility, which may be placed along the roadway, at intersections of the roadway, or other locations near the roadway. As respective vehicles traverse along the roadway, the connection between its client compute node 610 and a particular one of the edge gateway nodes 620 may propagate so as to maintain a consistent connection and context for the example client compute node 610. Likewise, mobile edge nodes may aggregate at the high priority services or according to the throughput or latency resolution requirements for the underlying service(s) (e.g., in the case of drones). The respective edge gateway devices 620 include an amount of processing and storage capabilities and, as such, some processing and/or storage of data for the client compute nodes 610 may be performed on one or more of the edge gateway nodes 620.

The edge gateway nodes 620 may communicate with one or more edge resource nodes 640, which are illustratively embodied as compute servers, appliances or components located at or in a communication base station 642 (e.g., a based station of a cellular network). As discussed above, the respective edge resource node(s) 640 include an amount of processing and storage capabilities and, as such, some processing and/or storage of data for the client compute nodes 610 may be performed on the edge resource node(s) 640. For example, the processing of data that is less urgent or important may be performed by the edge resource node(s) 640, while the processing of data that is of a higher urgency or importance may be performed by the edge gateway devices 620 (depending on, for example, the capabilities of each component, or information in the request indicating urgency or importance). Based on data access, data location or latency, work may continue on edge resource nodes when the processing priorities change during the processing activity. Likewise, configurable systems or hardware resources themselves can be activated (e.g., through a local orchestrator) to provide additional resources to meet the new demand (e.g., adapt the compute resources to the workload data).

The edge resource node(s) 640 also communicate with the core data center 650, which may include compute servers, appliances, and/or other components located in a central location (e.g., a central office of a cellular communication network). The example core data center 650 may provide a gateway to the global network cloud 660 (e.g., the Internet) for the edge cloud 110 operations formed by the edge resource node(s) 640 and the edge gateway devices 620. Additionally, in some examples, the core data center 650 may include an amount of processing and storage capabilities and, as such, some processing and/or storage of data for the client compute devices may be performed on the core data center 650 (e.g., processing of low urgency or importance, or high complexity).

The edge gateway nodes 620 or the edge resource node(s) 640 may offer the use of stateful applications 632 and a geographic distributed database 634. Although the applications 632 and database 634 are illustrated as being horizontally distributed at a layer of the edge cloud 110, it will be understood that resources, services, or other components of the application may be vertically distributed throughout the edge cloud (including, part of the application executed at the client compute node 610, other parts at the edge gateway nodes 620 or the edge resource node(s) 640, etc.). Additionally, as stated previously, there can be peer relationships at any level to meet service objectives and obligations. Further, the data for a specific client or application can move from edge to edge based on changing conditions (e.g., based on acceleration resource availability, following the car movement, etc.). For instance, based on the “rate of decay” of access, prediction can be made to identify the next owner to continue, or when the data or computational access will no longer be viable. These and other services may be utilized to complete the work that is needed to keep the transaction compliant and lossless.

In further scenarios, a virtual execution environment (VEE) 636 (or pod of virtual execution environments) may be flexibly migrated from one of the edge nodes 620 to other edge nodes (e.g., another one of edge nodes 620, one of the edge resource node(s) 640, etc.) such that the virtual execution environment with an application and workload does not need to be reconstituted, re-compiled, re-interpreted in order for migration to work. However, in such settings, there may be some remedial or “swizzling” translation operations applied. For example, the physical hardware at the edge resource node(s) 640 may differ from the hardware at the edge gateway nodes 620 and therefore, the hardware abstraction layer (HAL) that makes up the bottom edge of the virtual execution environment will be re-mapped to the physical layer of the target edge node. This may involve some form of late-binding technique, such as binary translation of the HAL from the virtual execution environment native format to the physical hardware format, or may involve mapping interfaces and operations. A pod controller may be used to drive the interface mapping as part of the virtual execution environment lifecycle, which includes migration to/from different hardware environments.

The scenarios encompassed by FIG. 6 may utilize various types of mobile edge nodes, such as an edge node hosted in a vehicle (car/truck/tram/train) or other mobile unit, as the edge node will move to other geographic locations along the platform hosting it. With vehicle-to-vehicle communications, individual vehicles may even act as network edge nodes for other cars, (e.g., to perform caching, reporting, data aggregation, etc.). Thus, it will be understood that the application components provided in various edge nodes may be distributed in static or mobile settings, including coordination between some functions or operations at individual endpoint devices or the edge gateway nodes 620, some others at the edge resource node(s) 640, and others in the core data center 650 or global network cloud 660.

In further configurations, the edge computing system may implement FaaS computing capabilities through the use of respective executable applications and functions. In an example, a developer writes function code (e.g., “computer code” herein) representing one or more computer functions, and the function code is uploaded to a FaaS platform provided by, for example, an edge node or data center. A trigger such as, for example, a service use case or an edge processing event, initiates the execution of the function code with the FaaS platform.

In an example of FaaS, a virtual execution environment is used to provide an environment in which function code (e.g., an application which may be provided by a third party) is executed. The virtual execution environment may be any isolated-execution entity such as a process, a Docker or Kubernetes virtual execution environment, a virtual machine, etc. Within the edge computing system, various datacenter, edge, and endpoint (including mobile) devices are used to “spin up” functions (e.g., activate and/or allocate function actions) that are scaled on demand. The function code gets executed on the physical infrastructure (e.g., edge computing node) device and underlying virtualized virtual execution environments. Finally, virtual execution environment is “spun down” (e.g., deactivated and/or deallocated) on the infrastructure in response to the execution being completed.

Further aspects of FaaS may enable deployment of edge functions in a service fashion, including a support of respective functions that support edge computing as a service (Edge-as-a-Service or “EaaS”). Additional features of FaaS may include: a granular billing component that enables customers (e.g., computer code developers) to pay only when their code gets executed; common data storage to store data for reuse by one or more functions; orchestration and management among individual functions; function execution management, parallelism, and consolidation; management of virtual execution environment and function memory spaces; coordination of acceleration resources available for functions; and distribution of functions between virtual execution environments (including “warm” virtual execution environments, already deployed or operating, versus “cold” which require initialization, deployment, or configuration).

The edge computing system 600 can include or be in communication with an edge provisioning node 644. The edge provisioning node 644 can distribute software such as the example computer readable instructions 1382 of FIG. 13B, to various receiving parties for implementing any of the methods described herein. The example edge provisioning node 644 may be implemented by any computer server, home server, content delivery network, virtual server, software distribution system, central facility, storage device, storage node, data facility, cloud service, etc., capable of storing and/or transmitting software instructions (e.g., code, scripts, executable binaries, virtual execution environments, packages, compressed files, and/or derivatives thereof) to other computing devices. Component(s) of the example edge provisioning node 644 may be located in a cloud, in a local area network, in an edge network, in a wide area network, on the Internet, and/or any other location communicatively coupled with the receiving party(ies). The receiving parties may be customers, clients, associates, users, etc. of the entity owning and/or operating the edge provisioning node 644. For example, the entity that owns and/or operates the edge provisioning node 644 may be a developer, a seller, and/or a licensor (or a customer and/or consumer thereof) of software instructions such as the example computer readable instructions 1382 of FIG. 13B. The receiving parties may be consumers, service providers, users, retailers, OEMs, etc., who purchase and/or license the software instructions for use and/or re-sale and/or sub-licensing.

In an example, edge provisioning node 644 includes one or more servers and one or more storage devices. The storage devices host computer readable instructions such as the example computer readable instructions 1382 of FIG. 13B, as described below. Similarly to edge gateway devices 620 described above, the one or more servers of the edge provisioning node 644 are in communication with a base station 642 or other network communication entity. In some examples, the one or more servers are responsive to requests to transmit the software instructions to a requesting party as part of a commercial transaction. Payment for the delivery, sale, and/or license of the software instructions may be handled by the one or more servers of the software distribution platform and/or via a third party payment entity. The servers enable purchasers and/or licensors to download the computer readable instructions 1382 from the edge provisioning node 644. For example, the software instructions, which may correspond to the example computer readable instructions 1382 of FIG. 13B, may be downloaded to the example processor platform/s, which is to execute the computer readable instructions 1382 to implement the methods described herein.

In some examples, the processor platform(s) that execute the computer readable instructions 1382 can be physically located in different geographic locations, legal jurisdictions, etc. In some examples, one or more servers of the edge provisioning node 644 periodically offer, transmit, and/or force updates to the software instructions (e.g., the example computer readable instructions 1382 of FIG. 13B) to ensure improvements, patches, updates, etc. are distributed and applied to the software instructions implemented at the end user devices. In some examples, different components of the computer readable instructions 1382 can be distributed from different sources and/or to different processor platforms; for example, different libraries, plug-ins, components, and other types of compute modules, whether compiled or interpreted, can be distributed from different sources and/or to different processor platforms. For example, a portion of the software instructions (e.g., a script that is not, in itself, executable) may be distributed from a first source while an interpreter (capable of executing the script) may be distributed from a second source.

In further examples, any of the compute nodes or devices discussed with reference to the present edge computing systems and environment may be fulfilled based on the components depicted in FIGS. 13A and 13B. Respective edge compute nodes may be embodied as a type of device, appliance, computer, or other “thing” capable of communicating with other edge, networking, or endpoint components. For example, an edge compute device may be embodied as a personal computer, server, smartphone, a mobile compute device, a smart appliance, an in-vehicle compute system (e.g., a navigation system), a self-contained device having an outer case, shell, etc., or other device or system capable of performing the described functions.

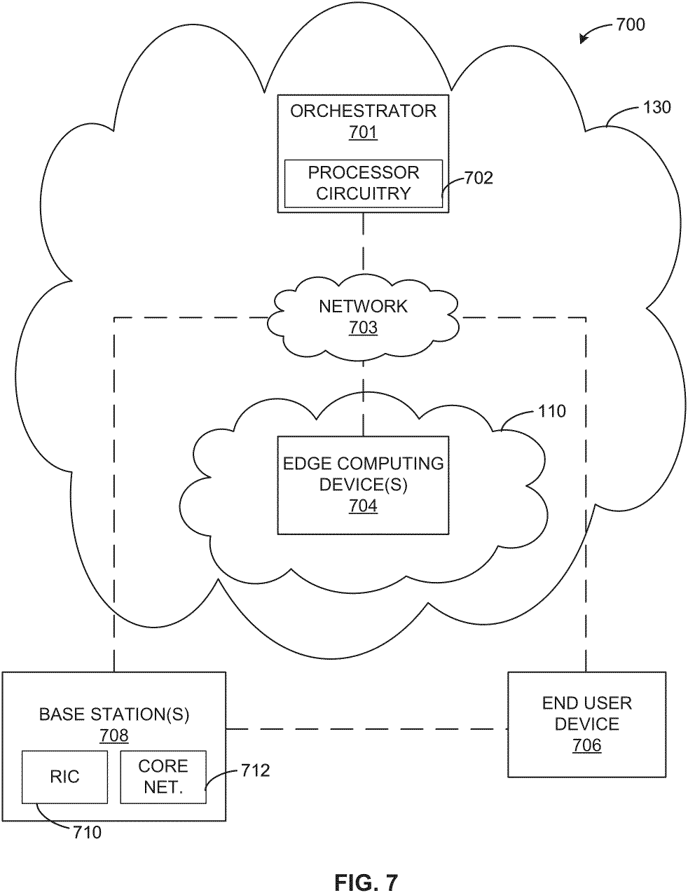

FIG. 7 is a block diagram of an example environment 700 to increase privacy for follow-me services in accordance with examples disclosed herein. The example environment 700 includes the example edge cloud 110 and the example cloud/data center 130 of FIGS. 1, 2, 3, and/or 6. The example environment 700 further includes an example orchestrator 701 including example processor circuitry 702, an example network 703, an example edge computing device(s) 704, an example end user device 706, and an example access device(s) 708. The example access device(s) 708 includes an example radio access network (RAN) intelligent controller circuitry (RIC) 710 and an example core network 712. Although the example of FIG. 7 corresponds to a cloud-based network, examples disclosed herein can be applied to any type of computing environment (e.g., virtual machines, racks of servers, etc.) and can be deployed anywhere between and/or including the edge computing device 704 up to the cloud 130. In some examples, the cloud/data center 130 corresponds to the cloud/data center 360, 440 of FIGS. 3 and/or 4 and/or the global network cloud 660 of FIG. 6. In some examples, the example edge computing device 704 may correspond to one or more of the example end points 160 of FIG. 1 and/or the example edge nodes 422, 424, 620, 644 of FIGS. 4 and/or 6. In some examples, the orchestrator 701 may correspond to one or more of the orchestrators 460, 531 of FIGS. 4 and/or 5. Although the example of FIG. 1 includes one orchestrator 701 and one edge computing device 704, there may be any number of clouds and/or edge computing devices. In some examples, the environment 700 may be a low trust or zero trust environment.

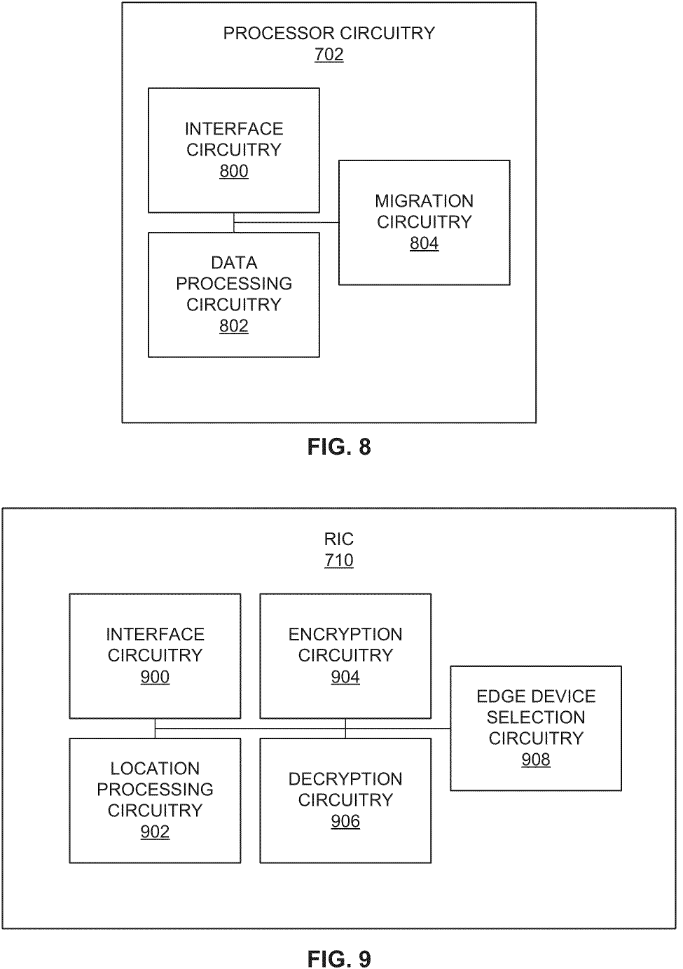

The example orchestrator 701 of FIG. 7 is a network device that provides a cloud-based and/or edge-based service. For example, the orchestrator 701 may be a computing device (e.g., a server) that interfaces with the example edge computing device 704 to monitor and/or facilitate operation of connected devices. In some examples, the orchestrator 701 is and/or is implemented by a cloud backend. In some examples, the orchestrator 701 is and/or is implemented by a server that implements and manages virtual machines or servers in a rack. In the example of FIG. 7 the orchestrator 701 is implemented in the cloud-based server 130. The example cloud-based server 130 may be implemented in a private cloud and/or a public cloud. In some examples, the orchestrator 701 is additionally or alternatively implemented in the edge cloud 110. The orchestrator 701 includes the processor circuitry 702 to process encrypted user and/or location information associated with the end user device 706 without decoding or otherwise determining the user and/or location information, as further described below in conjunction with FIG. 8.

The example network 703 of FIG. 7 is a system of interconnected systems exchanging data between the orchestrator 701 and processing devices (e.g., the example edge computing device 704). The example network 703 may be implemented using any type of public or private network such as, but not limited to, the Internet, a telephone network, a local area network (LAN), a cable network, and/or a wireless network. To enable communication via the example network 703, the orchestrator 701 and/or the edge computing device 704 includes a communication interface that enables a connection to an Ethernet, a digital subscriber line (DSL), a telephone line, a coaxial cable, any wireless connection, etc.

The example edge cloud 110 of FIG. 7 includes the example edge computing device 704. Although the example of FIG. 7 includes the example edge cloud 110, FIG. 7 may be described in conjunction with a fog domain, and IoT domain, a virtual machine (VM) domain, a multi-access edge computing (MEC) domain, etc. The example edge computing device 704 is a device that operates within the example edge cloud 110. The edge computing device 704 may be a server, a broker, an orchestrator, a fog device, a virtual machine, and/or any other type of computing device operating in a cloud-based environment. In some examples, the edge computing device 704 is a device (e.g., a mobile device, a camera, a drone, a smart device, a sensor, a server, a computer, a IoT device, and/or any other computing device) that interfaces with the example orchestrator 701 to access services of the orchestrator 701 (e.g., directly of via one or more gateway(s), edge device(s), etc.). The example edge computing device 704 can install a virtual execution environment to execute tasks corresponding to a service provided to the end user device 706. As used herein, a virtual execution environment may include and/or implement one or more virtual machine(s), container(s), producer application(s), and/or software to execute a portion of a workload corresponding to a service. The end user device 706 may implement an application that facilitates execution of a workload by a virtual execution environment implemented by the edge computing device 704. For example, if a user downloads an image processing application provided by a third party service provider that implements the edge computing device 704, the image processing application may instruct the edge computing device 704 to execute a workload to process image data at the edge computing device 704 (e.g., using the virtual execution environment) and return the results back to the end user device 706, thereby conserving resources of the end user device 706. In some examples, when the end user device 706 moves away from a first one of the edge computing devices 704, the first one of the edge computing devices 704 may receive instructions to migrate the virtual execution environment to another one of the edge computing device(s) 704 that is now located closer to the end user device 706 so that the second edge computing device can execute the workload, as further described below. In this manner, the service provided by the third party follows the end user device 706, regardless of the location of the end user device 706, to increase performance by decreasing latency, increasing throughput, etc.

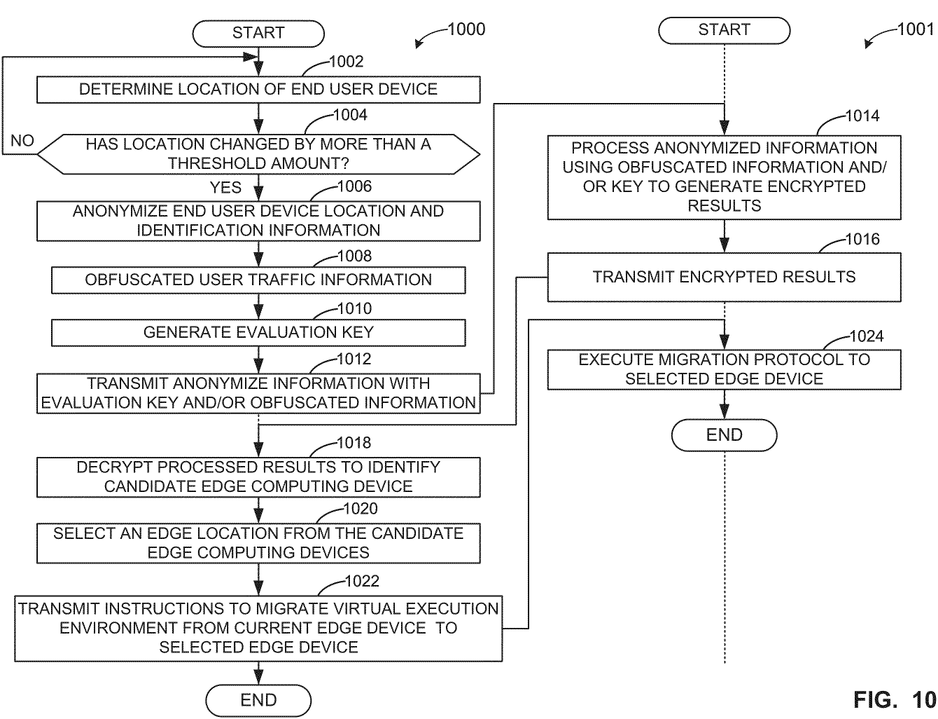

The example access device(s) 708 provide the end user device 706 connectivity to the network 703. In some examples, the access device(s) 708 are base stations that allow the end user device 706 to access the network 703. In some examples, the access device(s) 708 are cellular (e.g., 3G, 4G, 5G, etc.) base stations. In some examples, the access device(s) 708 are wireless fidelity (WI-FI) station(s) (e.g., access points). The base station(s) can determine detailed location information related to the location of the end user device 706 based on the signal obtained from the end user device 706 and/or the location of the access device(s) 708. Additionally, the access device 708 can determine user information and/or identifiers (IDs) related to the end user and/or the end user device 706. For example, if the end user device 706 is implemented in and/or is connected to a vehicle, the access device 708 can determine the vehicle identification number (VIN) of the vehicle and/or other identifying information. The access device(s) 708 include(s) the RIC circuitry 710 and the core network circuitry 712. The RIC circuitry 710 tracks the location of the end user device 706 and determines when to trigger a service migration of a virtual execution environment to execute a workload for the end user device 706 from a first edge computing device of the edge computing device(s) 704 to a second edge computing device of the edge computing device(s) 704. When the RIC circuitry 710 determines that a service migration should occur, the RIC circuitry 710 encrypts (e.g., using an oblivious encryption protocol) the user identification (e.g., user identification information, an identifier, a VIN, etc.) and/or location information of the end user device 706 and generates an evaluation key. The core network circuitry 712 transmits the encrypted information and the evaluation key to the orchestrator 701 so that the processor circuitry 702 can identify candidate edge computing device(s) 704 located near the end user device 706 based on the obtained encrypted data. After the orchestrator 701 responds with candidate end computing device locations (e.g., obtained via the core network circuitry 712), the RIC circuitry 710 selects one of the candidate edge device locations based on the location of the candidate end computing devices with respect to the end user device, and/or the availability and/or capability of the edge computing device(s) 704. In some examples, the selection of the candidate edge device location is made at the orchestration level. For example, each compute domain (e.g., edge or cloud) includes a corresponding control domain that has the information to decide where the task needs to be scheduled. The information is forwarded from the edge/cloud control domain (e.g., the orchestrator 701) to the radio network domain (e.g., the base station) after identifying a specific edge location. After the RIC circuitry 710 selects the edge computing device to execute the workload the RIC circuitry 710 triggers a service migration protocol to cause the virtual execution environment needed to execute the workload to migrate from the previous edge computing device to the selected edge computing device 704. The example RIC circuitry 710 is further described below in conjunction with FIG. 9.

FIG. 8 illustrates a block diagram of the processor circuitry 702 in the orchestrator 701 of FIG. 7. The example processor circuitry 702 includes example interface circuitry 800 and example data processing circuitry 802.

The example interface circuitry 800 of FIG. 8 communicates with the example access device(s) 708 and/or the edge computing device(s) 704 via the example network 703. For example, the interface circuitry 800 may obtain encrypted data from the access device(s) 708 that includes end user device identification information and/or location information (e.g., corresponding to a location of the end user device 706). Additionally, the interface circuitry 800 obtains an evaluation key. The evaluation key allows the data processing circuitry 802 to process the obtained encrypted data without decrypting and/or otherwise determining the user identification and/or location information from the encrypted information. Additionally, after the data processing circuitry 802 determines candidate edge computing device locations to execute a workload, the interface circuitry 800 transmits information related to the candidate edge computing devices to the example access device 708 via the network 703.

The example data processing circuitry 802 of FIG. 8 uses the evaluation key to evaluate the encrypted information without decrypting the encrypted information. In this manner, the data processing circuitry 802 can use the key to verify that the end user is valid (e.g., based on encrypted user identification information and/or credential information) and select candidate edge computing device locations without being able to determine the identification or location of the end user device 706. The candidate edge computing device locations correspond to the edge computing devices 704 located near the end user device 706 (e.g., based on the encrypted location information). Using an oblivious processing protocol, the data processing circuitry 802 can process the encrypted information and use the encrypted information using the evaluation key to generate the candidate locations even though the processing circuitry 802 cannot access and/or determine the encrypted information. After the encrypted information is processed to identify candidate locations, the processing circuitry 802 instructs the interface circuitry 800 to transmit a response including the candidate ended computing device locations. Because the processed data is still encrypted without being decrypted, the response will already be encrypted. The response may include information needed to access and/or identify the candidate edge computing devices, such as an identifier, an IP address, a credential, etc.

The example migration circuitry 804 of FIG. 8 orchestrates the migration of a virtual execution environment from a first edge device location to a second edge device location selected by the RIC 710. To orchestrate the migration, the example migration circuitry 804 may execute a migration protocol. For example, the migration protocol may include instructing the selected edge computing device to download the virtual execution environment and executing workloads in parallel with the previous edge computing device until the selected edge computing device is fully functional. In this manner, the end user device 706 will not experience a disruption and/or delay in the execution of a workload corresponding to a service. Although the migration circuitry 804 is implemented in the processor circuitry 702 of the orchestrator 701 of FIG. 7, the migration circuitry 804 may be implemented in a separate device.

FIG. 9 illustrates a block diagram of the RIC circuitry 710 in the access device 708 of FIG. 7. The example RIC circuitry 710 includes example interface circuitry 900, example location processing circuitry 902, example encryption circuitry 904, example decryption circuitry 906, and example edge device selection circuitry 908.

The example interface circuitry 900 of FIG. 9 obtains information from the core network circuitry 712. For example, the interface circuitry 900 may obtain signal strength information corresponding to the location of the end user device 706 (e.g., from the end user device 706 and/or from other access devices). Additionally, the interface circuitry 900 can instruct the core network 712 to transmit encrypted data with an computation key to the example orchestrator 701 via the network 703. Additionally, the interface circuitry 900 can obtain an encrypted response from the orchestrator 701 that identifies candidate edge computing device locations for a migration of a virtual execution environment to execute a workload corresponding to a service for the end user device 706.

The example location processing circuitry 902 processes data corresponding to the location of the end user device 706 in order to determine the location of the end user device 706. For example, the location processing circuitry 902 may utilize signal strength indicators corresponding to the end user device 706 to identify the location of the end user device 706. The signal strength indicators may include a signal strength indicator that was obtained and/or determined locally and/or signal strength indicators obtained and/or determined at other access devices. For example, the location processing circuitry 902 can utilize the signal strength indicators from two or more access devices to triangulate the location of the end user device. The location processing circuitry 902 can determine the location of the end user device 706 using any location determination technique. Additionally, the example location processing circuitry 902 tracks the location of the end user device 706 to determine when the end user device 706 has moved by more than a threshold distance. In this manner, the location processing circuitry 902 can trigger a service migration protocol when the end user device 706 moves by more than a threshold distance (e.g., to determine if there is another edge computing device that is better suited to execute the producer application to process the workload for the end user device 706).

The example encryption circuitry 904 of FIG. 9 encrypts the location and/or end user device identification information (e.g., an identifier, identifying information, VIN, etc.). In some examples, the encryption circuitry 904 may obtain credential information from the end user device 706 (e.g., via the interface circuitry 900). In such examples, the encryption circuitry 904 can encrypt the credential information. Additionally, the encryption circuitry 904 generates a computation key. As described above, the computation key allows the orchestrator 701 to process the encrypted identification, location, and/or credential information using the computation key without decrypting and/or otherwise determining the identification, location, and/or credential information, thereby preserving the privacy of the user of the end user device 706. In this manner, follow-me services can occur to migrate a virtual execution environment to an edge device near the end user device 706 when the end user device 706 moves without the third party service provider being able to determine the location and/or identification information corresponding to the end user device 706. In some examples, the encryption circuitry 904 encrypts the identification, location, and/or credential information in response to a trigger signal from the location processing circuitry 902. The encryption circuitry 904 instructs the interface circuitry 900 to transmit one or more data packets including the encrypted data to the orchestrator 701 via the core network circuitry 712.

The example decryption circuitry 906 of FIG. 9 obtains an encrypted response from the orchestrator 701 that includes the location of candidate edge computing devices 704 selected by orchestrator 701. As described above, the candidate edge computing devices 704 are selected based on their proximity to the end user device 706. The decryption circuitry 906 decrypts the encrypted response from the orchestrator 701 to determine the candidate edge computing devices 704. Because the orchestrator 701 processed, but did not decrypt, the encrypted information from the encryption circuitry 904, the response is still encrypted based on the encryption technique performed by the encryption circuitry 904. Accordingly, the decryption circuitry 906 decrypts the response based on the encryption technique used by the encryption circuitry 904 to determine the candidate edge computing devices.

The example edge device selection circuitry 908 of FIG. 9 selects one of the candidate edge computing devices to service workloads for the end user device 706. For example, the edge device selection circuitry 908 may communicate (e.g., via the interface circuitry 900 and/or the core network 712) with the candidate edge computing devices of the edge computing devices 704 and/or the orchestrator 701 to determine the capabilities and/or capacities of the candidate edge computing devices. The edge device selection circuitry 908 selects one of the candidate edge computing device(s) 704 to migrate virtual execution environment from the previous edge computing device to execute a workload for the end user device 706. In some examples, the edge device selection circuitry 908 selects the candidate edge computing devices based on the capability (e.g., able to execute the workload), capacity (e.g., have resources available to execute the workload), and/or location (e.g., with respect to the location of the end user device 706) of the candidate edge computing devices. The edge device selection circuitry 908 may weigh any one or more of the capability, capacity, and/or location more or less based on user and/or manufacturer preferences. After the edge device selection circuitry 908 selects an edge computing device, the edge device selection circuitry 908 instructs (e.g., by sending one or more instructions via the interface circuitry 900 and/or the core network 712) the edge computing device 704 that is currently executing the workload to migrate the virtual execution environment corresponding to the workload to the selected edge computing device (e.g., directly or via the orchestrator 701). The instructions may correspond to a migration protocol to ensure that the service provided to the end user device 706 is not interrupted before, after, and/or during the migration.

While an example manner of implementing the processor circuitry 702 and/or RIC circuitry 710 of FIG. 7 is illustrated in FIGS. 8 and 9, one or more of the elements, processes, and/or devices illustrated in FIGS. 8 and/or 9 may be combined, divided, rearranged, omitted, eliminated, and/or implemented in any other way. Further, the interface circuitry 800, the data processing circuitry 802, the migration circuitry 804, the interface circuitry 900, the location processing circuitry 902, the encryption circuitry 904, the decryption circuitry 906, the edge device selection circuitry 9082 and/or, more generally, the example processor circuitry 702 and/or the RIC circuitry 710 of FIGS. 8 and/or 9, may be implemented by hardware alone or by hardware in combination with software and/or firmware. Thus, for example, any of the interface circuitry 800, the data processing circuitry 802, the migration circuitry 804, the interface circuitry 900, the location processing circuitry 902, the encryption circuitry 904, the decryption circuitry 906, the edge device selection circuitry 9082 and/or, more generally, the example processor circuitry 702 and/or the RIC circuitry 710 of FIGS. 8 and/or 9, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example the example processor circuitry 702 and/or the RIC circuitry 710 of FIGS. 8 and/or 9 may include one or more elements, processes, and/or devices in addition to, or instead of, those illustrated in FIGS. 8 and/or 9, and/or may include more than one of any or all of the illustrated elements, processes, and devices.

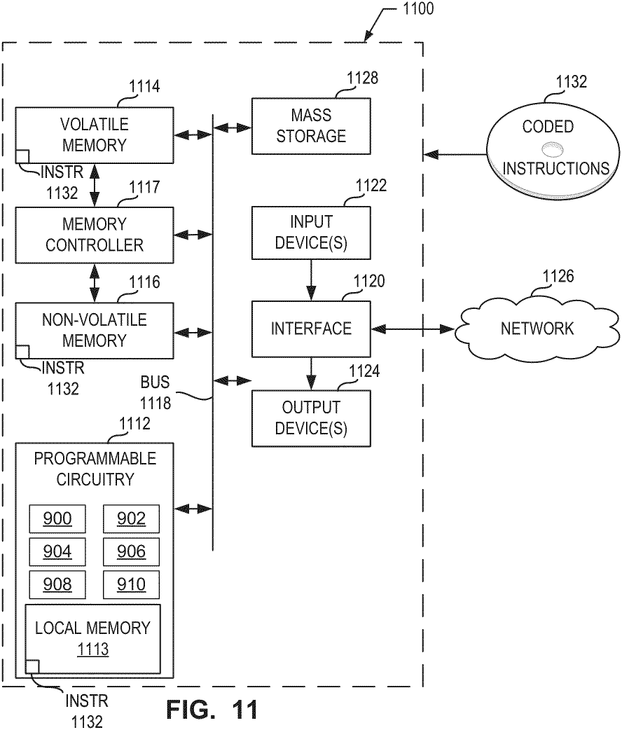

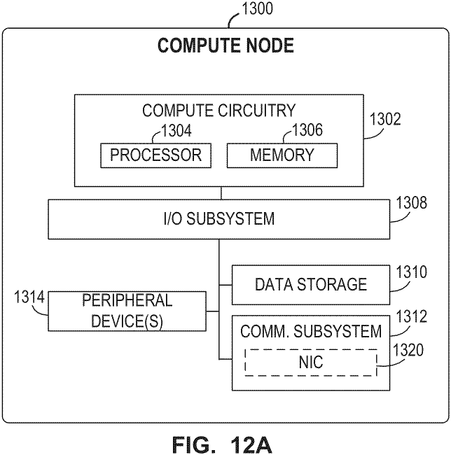

Flowchart(s) representative of example machine readable instructions, which may be executed by programmable circuitry to implement and/or instantiate the example processor circuitry 702 and/or the RIC circuitry 710 of FIGS. 8 and/or 9 and/or representative of example operations which may be performed by programmable circuitry to implement and/or instantiate the example processor circuitry 702 and/or the RIC circuitry 710 of FIGS. 8 and/or 9, are shown in FIGS. 10 and/or 12B. The machine readable instructions may be one or more executable programs or portion(s) of one or more executable programs for execution by programmable circuitry such as the programmable circuitry 1112, 1252 shown in the example processor platform 1100, 1250 discussed below in connection with FIGS. 11 and/or 12B and/or may be one or more function(s) or portion(s) of functions to be performed by the example programmable circuitry (e.g., an FPGA) discussed below in connection with FIGS. 13 and/or 14. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIG. 10, many other methods of implementing the example the example processor circuitry 702 and/or the RIC circuitry 710 of FIGS. 8 and/or 9 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 10 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/ or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 10 is a flowchart representative of example machine readable instructions and/or example operations 1000 that may be executed, instantiated, and/or performed by programmable circuitry(ies) to increase privacy for follow-me services. For example, the example operations 1000 may be executed, instantiated, and/or performed by the RIC circuitry 710 of FIG. 9 and the example operations 1001 may be executed, instantiated, and/or performed by the processor circuitry 702 of FIG. 8. The example machine-readable instructions and/or the example operations 1000 of FIG. 10 begin at block 1002, at which the location processing circuitry 902 determines the location of the end user device 706. As described above, the location processing circuitry 902 may determine the location of the end user device 706 based on the signal strength(s) determined at one or more access device(s) 708. For example, the RIC 710 may determine the signal strength of a signal from the end user device 706, obtain signal strength from other access devices, and determine the location of the end user device 706 based on the signal strengths and the location of the access devices.

At block 1004, the location processing circuitry 902 determines if the location of the end user device 706 has changed by more than a threshold amount. The threshold amount may be any threshold based on user and/or manufacturer preferences. In some examples, the location processing circuitry 902 may additionally or alternatively determine when a threshold amount of time has occurred. For example, if more than a threshold amount of time has occurred without migrating the virtual execution environment the location processing circuitry 902 may transmit anonymized location information to the orchestrator 701 to determine if the virtual execution environment should be migrated to a different edge computing device 704.

If the location processing circuitry 902 determines that the location of the end user device 706 has not changed by more than a threshold amount (block 1004: NO), control returns to block 1002. If the location processing circuitry 902 determines that the location of the end user device 706 has changed by more than a threshold amount (block 1004: YES), the example encryption circuitry 904 anonymizes end user device location and identification information (e.g., an identifier, a VIN, etc.) by encrypting the end user device location and identification information using an oblivious encryption technique (block 1006). At block 1008, the encryption circuitry 904 obfuscates the user traffic corresponding to the end user device 706. In some examples, the user traffic is provided to the orchestrator 701 to allow the cloud backend to be able to identify and associate user information without identifying a user association with the service.

At block 1010, the example encryption circuitry 904 generates an evaluation key for evaluating the encrypted and/or obfuscated information without being able to determine the encrypted and/or obfuscated information. As described above, the orchestrator 701 can use the evaluation key to process the identification, location, and/or traffic information to verify a user and identify edge computing devices 704 located near the end user device 706 without decrypting and/or otherwise determining the encrypted information. At block 1012, the example interface circuitry 900 transmits the anonymized information and/or obfuscated information with the evaluation key to the interface circuitry 800 of the processing circuitry 802 in the orchestrator 701 via the network 703 (e.g., using the example core network 712).

At block 1014, the example data processing circuitry 802 of the processor circuitry 702 in the orchestrator 701 processes the anonymized information and/or obfuscated information using the evaluation key to generate encrypted results by (a) verifying that user and/or service and/or (b) selecting candidate edge computing devices based on the identification, location, and/or traffic information. At block 1016, the example interface circuitry 800 transmits the encrypted results (e.g., the candidate edge computing device(s)) to the example access device 708 via the network 703. Because the encrypted data was processed without decrypting the data, the results are encrypted without the orchestrator 701 needing to encrypt the results.

At block 1018, the example decryption circuitry 906 decrypts the processed results to identify the candidate edge locations generated by the orchestrator 701. The decryption circuitry 906 decrypts the processed results based on the encryption technique performed at block 1006. At block 1020, the example device edge selection circuitry 908 selects an edge computing device from the candidate edge computing device. As described above, the edge device selection circuitry 908 may communicate with the candidate edge computing device(s) 704 and/or one or more orchestrators to determine the capability, capacity, and/or location of the candidate edge computing devices. The edge device selection circuitry 908 selects one of the candidate edge computing devices based on the capability, capacity, and/or location of the candidate edge computing device. At block 1022, the example interface circuitry 900 transmits instructions to the orchestrator 701 to migrate a virtual execution environment the edge computing device that is currently executing a workload for the end user device 706 to the selected edge computing device. In some examples, the interface circuitry 900 can transmit the instructions to the core network 712 to transmit the mitigation instructions directly to the edge computing device that is currently executing the workload and/or the selected edge computing device. In some examples, the encryption circuitry 904 encrypts (e.g., using oblivious encryption) the instructions to the core network 712 to cause migration of the workload.

At block 1024, the migration circuitry 804 of the orchestrator 701 executes the migration protocol to migrate the virtual execution environment to the selected edge device. The migration protocol transfers the virtual execution environment to the selected edge computing device so that the workload can be transferred to and/or executed by the selected edge computing device to continue the service for the end user device 706. In this manner, the service follows the end user device 706 as the end user device 706 moves by migrating the virtual execution environment to an edge device near the end user device 706 to execute a workload corresponding to the service.

FIG. 11 is a block diagram of an example programmable circuitry platform 1100 structured to execute and/or instantiate the example machine-readable instructions and/or the example operations of FIG. 10 to implement the processor circuitry 702 and/or RIC circuitry 710 of FIGS. 8 and/or 9. The programmable circuitry platform 1100 can be, for example, a server, a personal computer, a workstation, a self-learning machine (e.g., a neural network), or any other type of computing and/or electronic device.

The programmable circuitry platform 1100 of the illustrated example includes programmable circuitry 1112. The programmable circuitry 1112 of the illustrated example is hardware. For example, the programmable circuitry 1112 can be implemented by one or more integrated circuits, logic circuits, FPGAs, microprocessors, CPUs, GPUs, DSPs, and/or microcontrollers from any desired family or manufacturer. The programmable circuitry 1112 may be implemented by one or more semiconductor based (e.g., silicon based) devices. In this example, the programmable circuitry 1112 implements the interface circuitry 900, the location processing circuitry 902, the encryption circuitry 904, the decryption circuitry 906, and/or the edge device selection circuitry of FIG. 9.

The programmable circuitry 1112 of the illustrated example includes a local memory 1113 (e.g., a cache, registers, etc.). The programmable circuitry 1112 of the illustrated example is in communication with main memory 1114, 1116, which includes a volatile memory 1114 and a non-volatile memory 1116, by a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. Access to the main memory 1114, 1116 of the illustrated example is controlled by a memory controller 1117. In some examples, the memory controller 1117 may be implemented by one or more integrated circuits, logic circuits, microcontrollers from any desired family or manufacturer, or any other type of circuitry to manage the flow of data going to and from the main memory 1114, 1116.

The programmable circuitry platform 1100 of the illustrated example also includes interface circuitry 1120. The interface circuitry 1120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1122 are connected to the interface circuitry 1120. The input device(s) 1122 permit(s) a user (e.g., a human user, a machine user, etc.) to enter data and/or commands into the programmable circuitry 1112. The input device(s) 1122 can be implemented by, for example, a keyboard, a button, a mouse, and/or a touchscreen.

One or more output devices 1124 are also connected to the interface circuitry 1120 of the illustrated example. The output device(s) 1124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), and/or speaker. The interface circuitry 1120 of the illustrated example, thus, typically includes a graphics driver card, a graphics driver chip, and/or graphics processor circuitry such as a GPU.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1100 of the illustrated example also includes one or more mass storage discs or devices 1128 to store firmware, software, and/or data. Examples of such mass storage discs or devices 1128 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1132, which may be implemented by the machine readable instructions of FIG. 10, may be stored in the mass storage device 1128, in the volatile memory 1114, in the non-volatile memory 1116, and/or on at least one non-transitory computer readable storage medium such as a CD or DVD which may be removable.

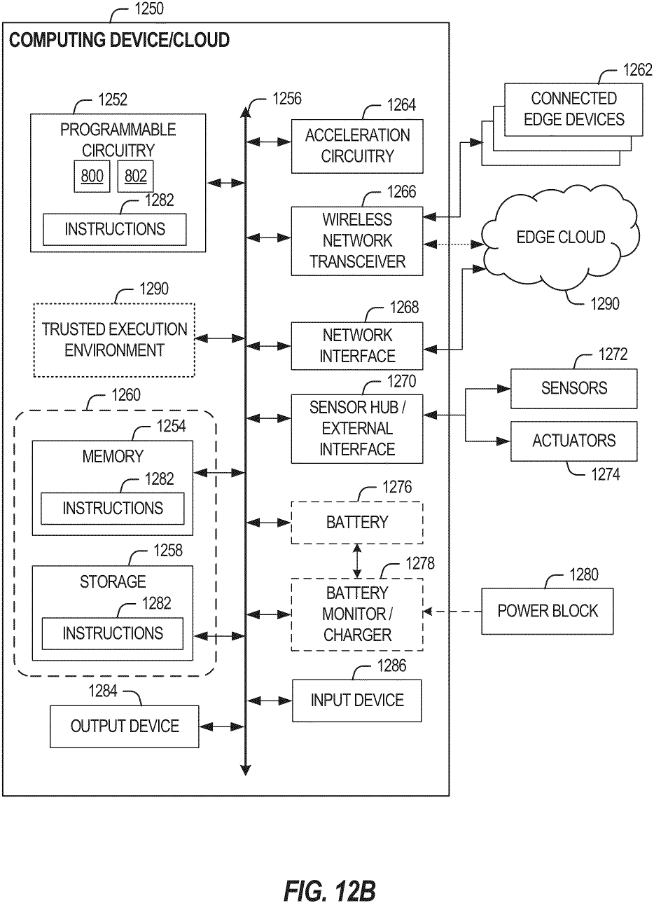

FIG. 12A is a block diagram of an example implementation of an example edge compute node 1200 that includes a compute engine (also referred to herein as “compute circuitry”) 1202, an input/output (I/O) subsystem 1208, data storage 1210, a communication circuitry subsystem 1212, and, optionally, one or more peripheral devices 1214. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component. The example edge compute node 1200 of FIG. 12 may be deployed in one of the edge computing systems illustrated in FIGS. 1-4 and/or 6-7 to implement any edge compute node of FIGS. 1-4 and/or 6-7.

The example compute node 1200 may be embodied as any type of engine, device, or collection of devices capable of performing various compute functions. In some examples, the compute node 1200 may be embodied as a single device such as an integrated circuit, an embedded system, a field-programmable gate array (FPGA), a system-on-a-chip (SOC), or other integrated system or device. In the illustrative example, the compute node 1200 includes or is embodied as a processor 1204 and a memory 1206. The example processor 1204 may be embodied as any type of processor capable of performing the functions described herein (e.g., executing an application). For example, the processor 1204 may be embodied as a multi-core processor(s), a microcontroller, a processing unit, a specialized or special purpose processing unit, or other processor or processing/controlling circuit.

In some examples, the processor 1204 may be embodied as, include, or be coupled to an FPGA, an application specific integrated circuit (ASIC), reconfigurable hardware or hardware circuitry, or other specialized hardware to facilitate performance of the functions described herein. Also in some examples, the processor 1204 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC), acceleration circuitry, storage devices, or AI hardware (e.g., GPUs or programmed FPGAs). Such an xPU may be designed to receive programming to process one or more data streams and perform specific tasks and actions for the data streams (such as hosting microservices, performing service management or orchestration, organizing, or managing server or data center hardware, managing service meshes, or collecting and distributing telemetry), outside of the CPU or general purpose processing hardware. However, it will be understood that a xPU, a SOC, a CPU, and other variations of the processor 1204 may work in coordination with each other to execute many types of operations and instructions within and on behalf of the compute node 1200.

The example memory 1206 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In an example, the memory device 1206 is a block addressable memory device, such as those based on NAND or NOR technologies. A memory device 1206 may also include a three dimensional crosspoint memory device (e.g., Intel® 3D XPoint™ memory), or other byte addressable write-in-place nonvolatile memory devices. The memory device 1206 may refer to the die itself and/or to a packaged memory product. In some examples, 3D crosspoint memory (e.g., Intel® 3D XPoint™ memory) may comprise a transistor-less stackable cross point architecture in which memory cells sit at the intersection of word lines and bit lines and are individually addressable and in which bit storage is based on a change in bulk resistance. In some examples, all or a portion of the memory 1206 may be integrated into the processor 1204. The memory 1206 may store various software and data used during operation such as one or more applications, data operated on by the application(s), libraries, and drivers.

The example compute circuitry 1202 is communicatively coupled to other components of the compute node 1200 via the I/O subsystem 1208, which may be embodied as circuitry and/or components to facilitate input/output operations with the compute circuitry 1202 (e.g., with the processor 1204 and/or the main memory 1206) and other components of the compute circuitry 1202. For example, the I/O subsystem 1208 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 1208 may form a portion of a system-on-a-chip (SoC) and be incorporated, along with one or more of the processor 1204, the memory 1206, and other components of the compute circuitry 1202, into the compute circuitry 1202.

The one or more illustrative data storage devices 1210 may be embodied as any type of devices configured for short-term or long-term storage of data such as, for example, memory devices and circuits, memory cards, hard disk drives, solid-state drives, or other data storage devices. Individual data storage devices 1210 may include a system partition that stores data and firmware code for the data storage device 1210. Individual data storage devices 1210 may also include one or more operating system partitions that store data files and executables for operating systems depending on, for example, the type of compute node 1200.

The example communication circuitry 1212 may be embodied as any communication circuit, device, or collection thereof, capable of enabling communications over a network between the compute circuitry 1202 and another compute device (e.g., an edge gateway of an implementing edge computing system). The example communication circuitry 1212 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, a IoT protocol such as IEEE 802.15.4 or ZigBee®, low-power wide-area network (LPWAN) or low-power wide-area (LPWA) protocols, etc.) to effect such communication.

The illustrative communication circuitry 1212 includes a network interface controller (NIC) 1220, which may also be referred to as a host fabric interface (HFI). The example NIC 1220 may be embodied as one or more add-in-boards, daughter cards, network interface cards, controller chips, chipsets, or other devices that may be used by the compute node 1200 to connect with another compute device (e.g., an edge gateway node). In some examples, the NIC 1220 may be embodied as part of a system-on-a-chip (SoC) that includes one or more processors, or included on a multichip package that also contains one or more processors. In some examples, the NIC 1220 may include a local processor (not shown) and/or a local memory (not shown) that are both local to the NIC 1220. In such examples, the local processor of the NIC 1220 may be capable of performing one or more of the functions of the compute circuitry 1202 described herein. Additionally, or alternatively, in such examples, the local memory of the NIC 1220 may be integrated into one or more components of the client compute node at the board level, socket level, chip level, and/or other levels.

Additionally, in some examples, a respective compute node 1200 may include one or more peripheral devices 1214. Such peripheral devices 1214 may include any type of peripheral device found in a compute device or server such as audio input devices, a display, other input/output devices, interface devices, and/or other peripheral devices, depending on the particular type of the compute node 1200. In further examples, the compute node 1200 may be embodied by a respective edge compute node (whether a client, gateway, or aggregation node) in an edge computing system or like forms of appliances, computers, subsystems, circuitry, or other components.

In a more detailed example, FIG. 12B illustrates a block diagram of an example may computing device 1250 structured to execute the instructions of FIG. 10 to implement the techniques (e.g., operations, processes, methods, and methodologies) described herein such as the orchestrator 701 of FIGS. 7 and/or 8. This computing device 1250 provides a closer view of the respective components of node 1200 when implemented as or as part of a computing device (e.g., as a mobile device, a base station, server, gateway, etc.). The computing device 1250 may include any combinations of the hardware or logical components referenced herein, and it may include or couple with any device usable with an edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the computing device 1250, or as components otherwise incorporated within a chassis of a larger system. For example, the computing device 1250 can be, for example, a server, a personal computer, a workstation, a self-learning machine (e.g., a neural network), a mobile device (e.g., a cell phone, a smart phone, a tablet such as an iPadTM), a personal digital assistant (PDA), an Internet appliance, a DVD player, a CD player, a digital video recorder, a Blu-ray player, a gaming console, a personal video recorder, a set top box, a headset or other wearable device, an Internet of Things (IoT) device, or any other type of computing device.

The computing device 1250 may include processing circuitry in the form of a programmable circuitry 1252, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The programmable circuitry 1252 may be a part of a system on a chip (SoC) in which the programmable circuitry 1252 and other components are formed into a single integrated circuit, or a single package, such as the Edison™ or Galileo™ SoC boards from Intel Corporation, Santa Clara, California. As an example, the programmable circuitry 1252 may include an Intel® Architecture Core™ based CPU processor, such as a Quark™, an Atom™, an i3, an i5, an i14, an i9, or an MCU-class processor, or another such processor available from Intel®. However, any number other processors may be used, such as available from Advanced Micro Devices, Inc. (AMD®) of Sunnyvale, California, a MIPS®-based design from MIPS Technologies, Inc. of Sunnyvale, California, an ARM®-based design licensed from ARM Holdings, Ltd. or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc. The programmable circuitry 1252 and accompanying circuitry may be provided in a single socket form factor, multiple socket form factor, or a variety of other formats, including in limited hardware configurations or configurations that include fewer than all elements shown in FIG. 12B. In this example, the processor implements at least one of the example interface circuitry 800 and/or the data processing circuitry 802 of FIG. 8.

The programmable circuitry 1252 may communicate with a system memory 1254 over an interconnect 1256 (e.g., a bus). Any number of memory devices may be used to provide for a given amount of system memory. As examples, the memory 1254 may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD149F for DDR SDRAM, JESD149-2F for DDR2 SDRAM, JESD149-3F for DDR3 SDRAM, JESD149-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q114P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 1258 may also couple to the programmable circuitry 1252 via the interconnect 1256. In an example, the storage 1258 may be implemented via a solid-state disk drive (SSDD). Other devices that may be used for the storage 1258 include flash memory cards, such as Secure Digital (SD) cards, microSD cards, eXtreme Digital (XD) picture cards, and the like, and Universal Serial Bus (USB) flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 1258 may be on-die memory or registers associated with the programmable circuitry 1252. However, in some examples, the storage 1258 may be implemented using a micro hard disk drive (HDD). Further, any number of new technologies may be used for the storage 1258 in addition to, or instead of, the technologies described, such resistance change memories, phase change memories, holographic memories, or chemical memories, among others.

The components may communicate over the interconnect 1256. The interconnect 1256 may include any number of technologies, including industry standard architecture (ISA), extended ISA (EISA), peripheral component interconnect (PCI), peripheral component interconnect extended (PCIx), PCI express (PCIe), or any number of other technologies. The interconnect 1256 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 1256 may couple the programmable circuitry 1252 to a transceiver 1266, for communications with the connected edge devices 1262. The transceiver 1266 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 1262. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 1266 (or multiple transceivers) may communicate using multiple standards or radios for communications at a different range. For example, the computing device 1250 may communicate with close devices, e.g., within about 10 meters, using a local transceiver based on Bluetooth Low Energy (BLE), or another low power radio, to save power. More distant connected edge devices 1262, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 1266 (e.g., a radio transceiver) may be included to communicate with devices or services in the edge cloud 1295 via local or wide area network protocols. The wireless network transceiver 1266 may be a low-power wide-area (LPWA) transceiver that follows the IEEE 802.15.4, or IEEE 802.15.4g standards, among others. The computing device 1250 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 1266, as described herein. For example, the transceiver 1266 may include a cellular transceiver that uses spread spectrum (SPA/SAS) communications for implementing high-speed communications. Further, any number of other protocols may be used, such as Wi-Fi® networks for medium speed communications and provision of network communications. The transceiver 1266 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 1268 may be included to provide a wired communication to nodes of the edge cloud 1295 or to other devices, such as the connected edge devices 1262 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 1268 may be included to enable connecting to a second network, for example, a first NIC 1268 providing communications to the cloud over Ethernet, and a second NIC 1268 providing communications to other devices over another type of network.

Given the variety of types of applicable communications from the device to another component or network, applicable communications circuitry used by the device may include or be embodied by any one or more of components 1264, 1266, 1268, or 1270. Accordingly, in various examples, applicable means for communicating (e.g., receiving, transmitting, etc.) may be embodied by such communications circuitry.

The computing device 1250 may include or be coupled to acceleration circuitry 1264, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific edge computing tasks for service management and service operations discussed elsewhere in this document.

The interconnect 1256 may couple the programmable circuitry 1252 to a sensor hub or external interface 1270 that is used to connect additional devices or subsystems. The devices may include sensors 1272, such as accelerometers, level sensors, flow sensors, optical light sensors, camera sensors, temperature sensors, global navigation system (e.g., GPS) sensors, pressure sensors, barometric pressure sensors, and the like. The hub or interface 1270 further may be used to connect the computing device 1250 to actuators 1274, such as power switches, valve actuators, an audible sound generator, a visual warning device, and the like.

In some optional examples, various input/output (I/O) devices may be present within or connected to, the computing device 1250. For example, a display or other output device 1284 may be included to show information, such as sensor readings or actuator position. An input device 1286, such as a touch screen or keypad may be included to accept input. An output device 1284 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the computing device 1250. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 1276 may power the computing device 1250, although, in examples in which the computing device 1250 is mounted in a fixed location, it may have a power supply coupled to an electrical grid, or the battery may be used as a backup or for temporary capabilities. The battery 1276 may be a lithium ion battery, or a metal-air battery, such as a zinc-air battery, an aluminum-air battery, a lithium-air battery, and the like.

A battery monitor/charger 1278 may be included in the computing device 1250 to track the state of charge (SoCh) of the battery 1276, if included. The battery monitor/charger 1278 may be used to monitor other parameters of the battery 1276 to provide failure predictions, such as the state of health (SoH) and the state of function (SoF) of the battery 1276. The battery monitor/charger 1278 may include a battery monitoring integrated circuit, such as an LTC4020 or an LTC2990 from Linear Technologies, an ADT7488A from ON Semiconductor of Phoenix Arizona, or an IC from the UCD90xxx family from Texas Instruments of Dallas, TX. The battery monitor/charger 1278 may communicate the information on the battery 1276 to the programmable circuitry 1252 over the interconnect 1256. The battery monitor/charger 1278 may also include an analog-to-digital (ADC) converter that enables the programmable circuitry 1252 to directly monitor the voltage of the battery 1276 or the current flow from the battery 1276. The battery parameters may be used to determine actions that the computing device 1250 may perform, such as transmission frequency, mesh network operation, sensing frequency, and the like.

A power block 1280, or other power supply coupled to a grid, may be coupled with the battery monitor/charger 1278 to charge the battery 1276. In some examples, the power block 1280 may be replaced with a wireless power receiver to obtain the power wirelessly, for example, through a loop antenna in the computing device 1250. A wireless battery charging circuit, such as an LTC4020 chip from Linear Technologies of Milpitas, California, among others, may be included in the battery monitor/charger 1278. The specific charging circuits may be selected based on the size of the battery 1276, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 1258 may include instructions 1282 in the form of software, firmware, or hardware commands to implement the techniques described herein. Although such instructions 1282 are shown as code blocks included in the memory 1254 and the storage 1258, it may be understood that any of the code blocks may be replaced with hardwired circuits, for example, built into an application specific integrated circuit (ASIC).

In an example, the instructions 1282 provided via the memory 1254, the storage 1258, or the programmable circuitry 1252 may be embodied as a non-transitory, machine-readable medium 1260 including code to direct the programmable circuitry 1252 to perform electronic operations in the computing device 1250. The programmable circuitry 1252 may access the non-transitory, machine-readable medium 1260 over the interconnect 1256. For instance, the non-transitory, machine-readable medium 1260 may be embodied by devices described for the storage 1258 or may include specific storage units such as optical disks, flash drives, or any number of other hardware devices. The non-transitory, machine-readable medium 1260 may include instructions to direct the programmable circuitry 1252 to perform a specific sequence or flow of actions, for example, as described with respect to the flowchart(s) and block diagram(s) of operations and functionality depicted above. As used herein, the terms “machine-readable medium” and “computer-readable medium” are interchangeable.

Also in a specific example, the instructions 1282 on the programmable circuitry 1252 (separately, or in combination with the instructions 1282 of the machine readable medium 1260) may configure execution or operation of a trusted execution environment (TEE) 1290. In an example, the TEE 1290 operates as a protected area accessible to the programmable circuitry 1252 for secure execution of instructions and secure access to data. Various implementations of the TEE 1290, and an accompanying secure area in the programmable circuitry 1252 or the memory 1254 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 1250 through the TEE 1290 and the programmable circuitry 1252. As described above, the TEE 1290 may process privacy sensitive telemetry data (e.g., AI inference over telemetry data). In such examples, the TEE 1290 may ensure that the various interests (e.g., conditions) are met as a condition of acceptance and/or disclosure of the telemetry data.

In further examples, a machine-readable medium also includes any tangible medium that is capable of storing, encoding, or carrying instructions for execution by a machine and that cause the machine to perform any one or more of the methodologies of the present disclosure or that is capable of storing, encoding, or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., Hypertext Transfer Protocol (HTTP)).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

The machine executable instructions 1000 and 1001 of FIG. 10 may be stored in the memory 1254, the storage 1258, and/or on a removable non-transitory computer readable storage medium such as a CD or DVD.

FIG. 13 is a block diagram of an example implementation of the programmable circuitry 1112, 1252 of FIGS. 11 and 12B. In this example, the programmable circuitry 1112, 1252 of FIGS. 11 and 12B is implemented by a microprocessor 1300. For example, the microprocessor 1300 may be a general-purpose microprocessor (e.g., general-purpose microprocessor circuitry). The microprocessor 1300 executes some or all of the machine-readable instructions of the flowcharts of FIG. 10 to effectively instantiate the circuitry of FIG. 2 as logic circuits to perform operations corresponding to those machine readable instructions. In some such examples, the circuitry of FIGS. 8 and/or 9 is instantiated by the hardware circuits of the microprocessor 1300 in combination with the machine-readable instructions. For example, the microprocessor 1300 may be implemented by multi-core hardware circuitry such as a CPU, a DSP, a GPU, an XPU, etc. Although it may include any number of example cores 1302 (e.g., 1 core), the microprocessor 1300 of this example is a multi-core semiconductor device including N cores. The cores 1302 of the microprocessor 1300 may operate independently or may cooperate to execute machine readable instructions. For example, machine code corresponding to a firmware program, an embedded software program, or a software program may be executed by one of the cores 1302 or may be executed by multiple ones of the cores 1302 at the same or different times. In some examples, the machine code corresponding to the firmware program, the embedded software program, or the software program is split into threads and executed in parallel by two or more of the cores 1302. The software program may correspond to a portion or all of the machine readable instructions and/or operations represented by the flowcharts of FIG. 10.

The cores 1302 may communicate by a first example bus 1304. In some examples, the first bus 1304 may be implemented by a communication bus to effectuate communication associated with one(s) of the cores 1302. For example, the first bus 1304 may be implemented by at least one of an Inter-Integrated Circuit (I2C) bus, a Serial Peripheral Interface (SPI) bus, a PCI bus, or a PCIe bus. Additionally or alternatively, the first bus 1304 may be implemented by any other type of computing or electrical bus. The cores 1302 may obtain data, instructions, and/or signals from one or more external devices by example interface circuitry 1306. The cores 1302 may output data, instructions, and/or signals to the one or more external devices by the interface circuitry 1306. Although the cores 1302 of this example include example local memory 1320 (e.g., Level 1 (L1) cache that may be split into an L1 data cache and an L1 instruction cache), the microprocessor 1300 also includes example shared memory 1310 that may be shared by the cores (e.g., Level 2 (L2 cache)) for high-speed access to data and/or instructions. Data and/or instructions may be transferred (e.g., shared) by writing to and/or reading from the shared memory 1310. The local memory 1320 of each of the cores 1302 and the shared memory 1310 may be part of a hierarchy of storage devices including multiple levels of cache memory and the main memory (e.g., the main memory 1114, 1116, 1254, 1258 of FIGS. 11 and 12B). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1302 may be referred to as a CPU, DSP, GPU, etc., or any other type of hardware circuitry. Each core 1302 includes control unit circuitry 1314, arithmetic and logic (AL) circuitry (sometimes referred to as an ALU) 1316, a plurality of registers 1318, the local memory 1320, and a second example bus 1322. Other structures may be present. For example, each core 1302 may include vector unit circuitry, single instruction multiple data (SIMD) unit circuitry, load/store unit (LSU) circuitry, branch/jump unit circuitry, floating-point unit (FPU) circuitry, etc. The control unit circuitry 1314 includes semiconductor-based circuits structured to control (e.g., coordinate) data movement within the corresponding core 1302. The AL circuitry 1316 includes semiconductor-based circuits structured to perform one or more mathematic and/or logic operations on the data within the corresponding core 1302. The AL circuitry 1316 of some examples performs integer based operations. In other examples, the AL circuitry 1316 also performs floating-point operations. In yet other examples, the AL circuitry 1316 may include first AL circuitry that performs integer-based operations and second AL circuitry that performs floating-point operations. In some examples, the AL circuitry 1316 may be referred to as an Arithmetic Logic Unit (ALU).

The registers 1318 are semiconductor-based structures to store data and/or instructions such as results of one or more of the operations performed by the AL circuitry 1316 of the corresponding core 1302. For example, the registers 1318 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1318 may be arranged in a bank as shown in FIG. 13. Alternatively, the registers 1318 may be organized in any other arrangement, format, or structure, such as by being distributed throughout the core 1302 to shorten access time. The second bus 1322 may be implemented by at least one of an I2C bus, a SPI bus, a PCI bus, or a PCIe bus.

Each core 1302 and/or, more generally, the microprocessor 1300 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1300 is a semiconductor device fabricated to include many transistors interconnected to implement the structures described above in one or more integrated circuits (ICs) contained in one or more packages.

The microprocessor 1300 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1300, in the same chip package as the microprocessor 1300 and/or in one or more separate packages from the microprocessor 1300.

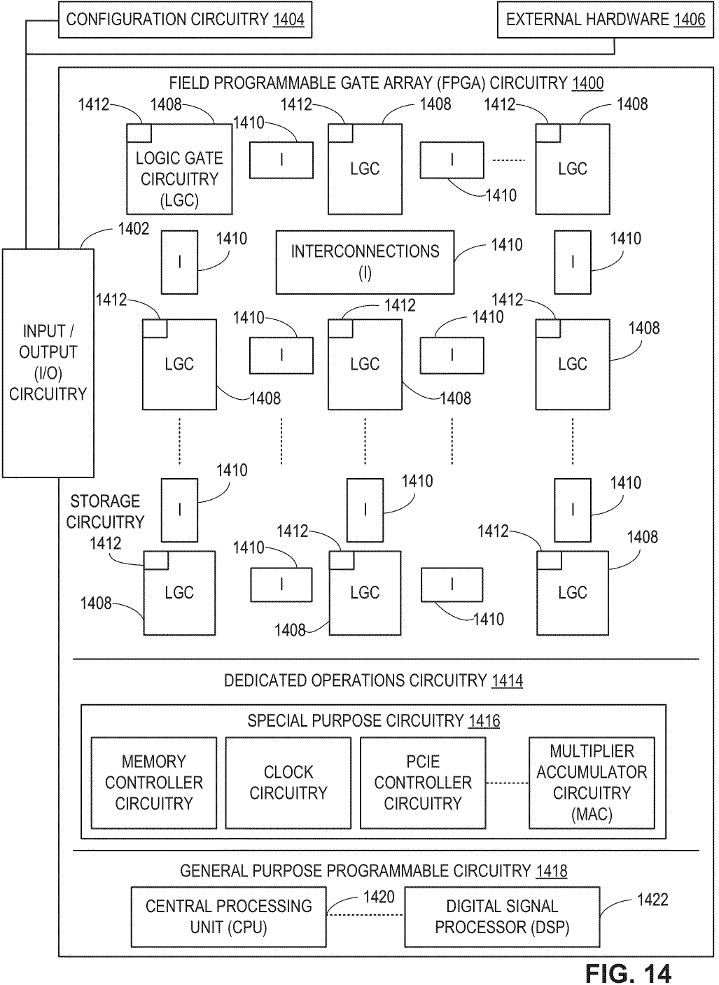

FIG. 14 is a block diagram of another example implementation of the programmable circuitry 1112, 1252 of FIGS. 11 and 12B. In this example, the programmable circuitry 1112, 1252 is implemented by FPGA circuitry 1400. For example, the FPGA circuitry 1400 may be implemented by an FPGA. The FPGA circuitry 1400 can be used, for example, to perform operations that could otherwise be performed by the example microprocessor 1300 of FIG. 13 executing corresponding machine readable instructions. However, once configured, the FPGA circuitry 1400 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1300 of FIG. 13 described above (which is a general purpose device that may be programmed to execute some or all of the machine readable instructions represented by the flowchart(s) of FIG. 10 but whose interconnections and logic circuitry are fixed once fabricated), the FPGA circuitry 1400 of the example of FIG. 14 includes interconnections and logic circuitry that may be configured, structured, programmed, and/or interconnected in different ways after fabrication to instantiate, for example, some or all of the operations/functions corresponding to the machine readable instructions represented by the flowchart(s) of FIG. 10. In particular, the FPGA circuitry 1400 may be thought of as an array of logic gates, interconnections, and switches. The switches can be programmed to change how the logic gates are interconnected by the interconnections, effectively forming one or more dedicated logic circuits (unless and until the FPGA circuitry 1400 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIG. 10. As such, the FPGA circuitry 1400 may be configured and/or structured to effectively instantiate some or all of the operations/functions corresponding to the machine readable instructions of the flowchart(s) of FIG. 10 as dedicated logic circuits to perform the operations/functions corresponding to those software instructions in a dedicated manner analogous to an ASIC. Therefore, the FPGA circuitry 1400 may perform the operations/functions corresponding to the some or all of the machine readable instructions of FIG. 10 faster than the general-purpose microprocessor can execute the same.

In the example of FIG. 14, the FPGA circuitry 1400 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1400 of FIG. 14 may access and/or load the binary file to cause the FPGA circuitry 1400 of FIG. 14 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1400 of FIG. 14 to cause configuration and/or structuring of the FPGA circuitry 1400 of FIG. 14, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1400 of FIG. 14 may access and/or load the binary file to cause the FPGA circuitry 1400 of FIG. 14 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1400 of FIG. 14 to cause configuration and/or structuring of the FPGA circuitry 1400 of FIG. 14, or portion(s) thereof.

The FPGA circuitry 1400 of FIG. 14, includes example input/output (I/O) circuitry 1402 to obtain and/or output data to/from example configuration circuitry 1404 and/or external hardware 1406. For example, the configuration circuitry 1404 may be implemented by interface circuitry that may obtain a binary file, which may be implemented by a bit stream, data, and/or machine-readable instructions, to configure the FPGA circuitry 1400, or portion(s) thereof. In some such examples, the configuration circuitry 1404 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1406 may be implemented by external hardware circuitry. For example, the external hardware 1406 may be implemented by the microprocessor 1300 of FIG. 13.

The FPGA circuitry 1400 also includes an array of example logic gate circuitry 1408, a plurality of example configurable interconnections 1410, and example storage circuitry 1412. The logic gate circuitry 1408 and the configurable interconnections 1410 are configurable to instantiate one or more operations/functions that may correspond to at least some of the machine readable instructions of FIG. 10 and/or other desired operations. The logic gate circuitry 1408 shown in FIG. 14 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1408 to enable configuration of the electrical structures and/or the logic gates to form circuits to perform desired operations/functions. The logic gate circuitry 1408 may include other electrical structures such as look-up tables (LUTs), registers (e.g., flip-flops or latches), multiplexers, etc.

The configurable interconnections 1410 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1408 to program desired logic circuits.

The storage circuitry 1412 of the illustrated example is structured to store result(s) of the one or more of the operations performed by corresponding logic gates. The storage circuitry 1412 may be implemented by registers or the like. In the illustrated example, the storage circuitry 1412 is distributed amongst the logic gate circuitry 1408 to facilitate access and increase execution speed.

The example FPGA circuitry 1400 of FIG. 14 also includes example dedicated operations circuitry 1414. In this example, the dedicated operations circuitry 1414 includes special purpose circuitry 1416 that may be invoked to implement commonly used functions to avoid the need to program those functions in the field. Examples of such special purpose circuitry 1416 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1400 may also include example general purpose programmable circuitry 1418 such as an example CPU 1420 and/or an example DSP 1422. Other general purpose programmable circuitry 1418 may additionally or alternatively be present such as a GPU, an XPU, etc., that can be programmed to perform other operations.

Although FIGS. 13 and 14 illustrate two example implementations of the programmable circuitry 1112, 1252 of FIGS. 11 and 12B, many other approaches are contemplated. For example, FPGA circuitry may include an on-board CPU, such as one or more of the example CPU 1420 of FIG. 13. Therefore, the programmable circuitry 1112, 1252 of FIGS. 11 and 12B may additionally be implemented by combining at least the example microprocessor 1300 of FIG. 13 and the example FPGA circuitry 1400 of FIG. 14. In some such hybrid examples, one or more cores 1302 of FIG. 13 may execute a first portion of the machine readable instructions represented by the flowchart(s) of FIG. 10 to perform first operation(s)/function(s), the FPGA circuitry 1400 of FIG. 14 may be configured and/or structured to perform second operation(s)/function(s) corresponding to a second portion of the machine readable instructions represented by the flowcharts of FIG. 10, and/or an ASIC may be configured and/or structured to perform third operation(s)/function(s) corresponding to a third portion of the machine readable instructions represented by the flowcharts of FIG. 10.

It should be understood that some or all of the circuitry of FIGS. 8 and/or 9 may, thus, be instantiated at the same or different times. For example, same and/or different portion(s) of the microprocessor 1300 of FIG. 13 may be programmed to execute portion(s) of machine-readable instructions at the same and/or different times. In some examples, same and/or different portion(s) of the FPGA circuitry 1400 of FIG. 14 may be configured and/or structured to perform operations/functions corresponding to portion(s) of machine-readable instructions at the same and/or different times.

In some examples, some or all of the circuitry of FIGS. 8 and/or 9 may be instantiated, for example, in one or more threads executing concurrently and/or in series. For example, the microprocessor 1300 of FIG. 13 may execute machine readable instructions in one or more threads executing concurrently and/or in series. In some examples, the FPGA circuitry 1400 of FIG. 14 may be configured and/or structured to carry out operations/functions concurrently and/or in series. Moreover, in some examples, some or all of the processor circuitry 702 and/or the RIC circuitry 710 of FIGS. 8 and/or 9 may be implemented within one or more virtual execution environment (e.g., virtual machines and/or containers) executing on the microprocessor 1300 of FIG. 13.

In some examples, the programmable circuitry 1112, 1252 of FIGS. 11 and 12B may be in one or more packages. For example, the microprocessor 1300 of FIG. 13 and/or the FPGA circuitry 1400 of FIG. 14 may be in one or more packages. In some examples, an XPU may be implemented by the programmable circuitry 1112, 1252 of FIGS. 11 and 12A, which may be in one or more packages. For example, the XPU may include a CPU (e.g., the microprocessor 1300 of FIG. 13, the CPU 1420 of FIG. 14, etc.) in one package, a DSP (e.g., the DSP 1422 of FIG. 14) in another package, a GPU in yet another package, and an FPGA (e.g., the FPGA circuitry 1400 of FIG. 14) in still yet another package.

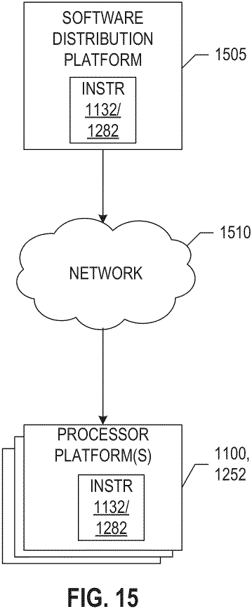

A block diagram illustrating an example software distribution platform 1505 to distribute software such as the example machine readable instructions 1132, 1282 of FIGS. 11 and 12A to other hardware devices (e.g., hardware devices owned and/or operated by third parties from the owner and/or operator of the software distribution platform) is illustrated in FIG. 15. The example software distribution platform 1505 may be implemented by any computer server, data facility, cloud service, etc., capable of storing and transmitting software to other computing devices. The third parties may be customers of the entity owning and/or operating the software distribution platform 1505. For example, the entity that owns and/or operates the software distribution platform 1505 may be a developer, a seller, and/or a licensor of software such as the example machine readable instructions 1132, 1282 of FIGS. 11 and 12B. The third parties may be consumers, users, retailers, OEMs, etc., who purchase and/or license the software for use and/or re-sale and/or sub-licensing. In the illustrated example, the software distribution platform 1505 includes one or more servers and one or more storage devices. The storage devices store the machine readable instructions 1132, 1282 which may correspond to the example machine readable instructions of FIG. 10, as described above. The one or more servers of the example software distribution platform 1505 are in communication with an example network 1510, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1132, 1282 from the software distribution platform 1505. For example, the software, which may correspond to the example machine readable instructions of FIG. 10, may be downloaded to the example programmable circuitry platform 1100, 1250 which is to execute the machine readable instructions 1132, 1282 to implement the processor circuitry 702 and/or the RIC circuitry 710. In some examples, one or more servers of the software distribution platform 1505 periodically offer, transmit, and/or force updates to the software (e.g., the example machine readable instructions 1132, 1282 of FIGS. 11 and 12B) to ensure improvements, patches, updates, etc., are distributed and applied to the software at the end user devices. Although referred to as software above, the distributed “software” could alternatively be firmware.

From the foregoing, it will be appreciated that example systems, apparatus, articles of manufacture, and methods have been disclosed that increase privacy for follow-me services. Disclosed systems, apparatus, articles of manufacture, and methods improve the efficiency of using a computing device and increase the performance of edge-based workload computation by migrating virtual execution environments based on the location of the end user device while maintaining the privacy (e.g., identity, location, etc.) of the end user device. Disclosed systems, apparatus, articles of manufacture, and methods are accordingly directed to one or more improvement(s) in the operation of a machine such as a computer, network and/or other electronic and/or mechanical device.

Example methods, apparatus, systems, and articles of manufacture to migrate cloud-based workloads are disclosed herein. Further examples and combinations thereof include the following: Example 1 includes a non-transitory machine readable storage medium comprising instructions to cause programmable circuitry to at least cause transmission of anonymized information corresponding to a user device to a network device, and cause migration of a virtual execution environment from a first compute device to a second compute device based on a response from the network device, the virtual execution environment to execute at least a portion of a workload for the user device.

Example 2 includes the machine readable storage medium of example 1, wherein the instructions cause the programmable circuitry to generate an evaluation key, the evaluation key to facilitate processing of the anonymized information without decrypting the anonymized information.

Example 3 includes the machine readable storage medium of example 2, wherein the evaluation key is to facilitate the processing of the anonymized information without the network device determining at least one of a location of the user device or an identity of the user device.

Example 4 includes the machine readable storage medium of example 1, wherein the instructions cause the programmable circuitry to encrypt location information corresponding to the user device using an oblivious encryption technique, the encrypted location information included in the anonymized information.

Example 5 includes the machine readable storage medium of example 4, wherein the instructions cause the programmable circuitry to encrypt the location information after a location of the user device has changed by more than a threshold amount.

Example 6 includes the machine readable storage medium of example 1, wherein the instructions cause the programmable circuitry to determine the second compute device based on the response from the network device.

Example 7 includes the machine readable storage medium of example 1, wherein the instructions cause the programmable circuitry to track a location of the user device.

Example 8 includes the machine readable storage medium of example 1, wherein the instructions cause the programmable circuitry to obfuscate user traffic information corresponding to the user device, and cause transmission of the obfuscated user traffic information to the network device.

Example 9 includes the machine readable storage medium of example 1, wherein the instructions cause the programmable circuitry to decrypt the response from the network device to identify candidate edge computing devices, and determine the second computing device based on at least one of a capability of the second computing device, a capacity of the second computing device, or a location of the second computing device.

Example 10 includes an apparatus to migrate cloud-based workloads, the apparatus comprising interface circuitry, machine readable instructions, and programmable circuitry to at least one of instantiate or execute the machine readable instructions to cause transmission of anonymized information corresponding to a user device to a network device, and cause migration of a virtual execution environment from a first compute device to a second compute device based on a response from the network device, the virtual execution environment to execute at least a portion of a workload for the user device.

Example 11 includes the apparatus of example 10, wherein the programmable circuitry is to generate an evaluation key, the evaluation key to facilitate processing of the anonymized information without decrypting the anonymized information.

Example 12 includes the apparatus of example 11, wherein the evaluation key is to facilitate the processing of the anonymized information without the network device determining at least one of a location of the user device or an identity of the user device.

Example 13 includes the apparatus of example 10, wherein the programmable circuitry is to encrypt location information corresponding to the user device using an oblivious encryption technique, the encrypted location information included in the anonymized information.

Example 14 includes the apparatus of example 13, wherein the programmable circuitry is to encrypt the location information after a location of the user device has changed by more than a threshold amount.

Example 15 includes the apparatus of example 10, wherein the programmable circuitry is to determine the second compute device based on the response from the network device.

Example 16 includes the apparatus of example 10, wherein the programmable circuitry is to track a location of the user device.

Example 17 includes the apparatus of example 10, wherein the programmable circuitry is to encrypt identification information corresponding to the user device, the encrypted identification information included in the anonymized information.

Example 18 includes the apparatus of example 10, wherein the programmable circuitry is to obfuscate user traffic information corresponding to the user device, and cause transmission of the obfuscated user traffic information to the network device.

Example 19 includes the apparatus of example 10, wherein the programmable circuitry is to decrypt the response from the network device to identify candidate edge computing devices, and determine the second computing device based on at least one of a capability of the second computing device, a capacity of the second computing device, or a location of the second computing device.

Example 20 includes a non-transitory machine readable storage medium comprising interface circuitry to cause transmission of anonymized information corresponding to a user device to a network device, and edge device selection circuitry to cause migration of a virtual execution environment from a first compute device to a second compute device based on a response from the network device, the virtual execution environment to execute at least a portion of a workload for the user device.

Example 21 includes a non-transitory machine readable storage medium comprising instructions to cause programmable circuitry to at least process anonymized information using a key, the processing of the anonymized information performed without determining the anonymized information to generate a list of candidate edge computing devices to execute a workload, cause transmission of the list of candidate edge computing devices, and execute a migration protocol to migrate a virtual execution environment to a selected edge computing device from the list of candidate edge computing devices.

Example 22 includes the non-transitory machine readable storage medium of example 21, wherein the anonymized information is encrypted, the programmable circuitry to process the anonymized information without decrypting the anonymized information.

Example 23 includes the non-transitory machine readable storage medium of example 21, wherein the anonymized information includes location information, programmable circuitry is to generate the list of candidate edge computing devices based on the location information.

Example 24 includes the non-transitory machine readable storage medium of example 23, wherein the programmable circuitry is to generate the list of candidate edge computing devices based on the location information without determining the location information. devices based on the location information.

Example 25 includes the non-transitory machine readable storage medium of example 21, wherein the programmable circuitry is to execute the migration protocol for an end user device without knowing identification information corresponding to the end user device.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A non-transitory machine readable storage medium comprising instructions to cause programmable circuitry to at least:
cause transmission of anonymized information corresponding to a user device to a network device; and
cause migration of a virtual execution environment from a first compute device to a second compute device based on a response from the network device, the virtual execution environment to execute at least a portion of a workload for the user device.

2. The machine readable storage medium of claim 1, wherein the instructions cause the programmable circuitry to generate an evaluation key, the evaluation key to facilitate processing of the anonymized information without decrypting the anonymized information.

3. The machine readable storage medium of claim 2, wherein the evaluation key is to facilitate the processing of the anonymized information without the network device determining at least one of a location of the user device or an identity of the user device.

4. The machine readable storage medium of claim 1, wherein the instructions cause the programmable circuitry to encrypt location information corresponding to the user device using an oblivious encryption technique, the encrypted location information included in the anonymized information.

5. The machine readable storage medium of claim 4, wherein the instructions cause the programmable circuitry to encrypt the location information after a location of the user device has changed by more than a threshold amount.

6. The machine readable storage medium of claim 1, wherein the instructions cause the programmable circuitry to determine the second compute device based on the response from the network device.

7. The machine readable storage medium of claim 1, wherein the instructions cause the programmable circuitry to track a location of the user device.

8. The machine readable storage medium of claim 1, wherein the instructions cause the programmable circuitry to:
obfuscate user traffic information corresponding to the user device; and
cause transmission of the obfuscated user traffic information to the network device.

9. The machine readable storage medium of claim 1, wherein the instructions cause the programmable circuitry to:
decrypt the response from the network device to identify candidate edge computing devices; and
determine the second computing device based on at least one of a capability of the second computing device, a capacity of the second computing device, or a location of the second computing device.

10. An apparatus to migrate cloud-based workloads, the apparatus comprising:
interface circuitry;
machine readable instructions; and
programmable circuitry to at least one of instantiate or execute the machine readable instructions to:
cause transmission of anonymized information corresponding to a user device to a network device; and
cause migration of a virtual execution environment from a first compute device to a second compute device based on a response from the network device, the virtual execution environment to execute at least a portion of a workload for the user device.

11. The apparatus of claim 10, wherein the programmable circuitry is to generate an evaluation key, the evaluation key to facilitate processing of the anonymized information without decrypting the anonymized information.

12. The apparatus of claim 11, wherein the evaluation key is to facilitate the processing of the anonymized information without the network device determining at least one of a location of the user device or an identity of the user device.

13. The apparatus of claim 10, wherein the programmable circuitry is to encrypt location information corresponding to the user device using an oblivious encryption technique, the encrypted location information included in the anonymized information.

14. The apparatus of claim 13, wherein the programmable circuitry is to encrypt the location information after a location of the user device has changed by more than a threshold amount.

15. The apparatus of claim 10, wherein the programmable circuitry is to determine the second compute device based on the response from the network device.

16. The apparatus of claim 10, wherein the programmable circuitry is to track a location of the user device.

17. The apparatus of claim 10, wherein the programmable circuitry is to encrypt identification information corresponding to the user device, the encrypted identification information included in the anonymized information.

18. The apparatus of claim 10, wherein the programmable circuitry is to:
obfuscate user traffic information corresponding to the user device; and
cause transmission of the obfuscated user traffic information to the network device.

19. The apparatus of claim 10, wherein the programmable circuitry is to:
decrypt the response from the network device to identify candidate edge computing devices; and
determine the second computing device based on at least one of a capability of the second computing device, a capacity of the second computing device, or a location of the second computing device.

20. A non-transitory machine readable storage medium comprising:
interface circuitry to cause transmission of anonymized information corresponding to a user device to a network device; and
edge device selection circuitry to cause migration of a virtual execution environment from a first compute device to a second compute device based on a response from the network device, the virtual execution environment to execute at least a portion of a workload for the user device.
